(19) United States
(12) Patent Application Publication
(10) Pub. No.: US 2004/0236474 A1
(43) Pub. Date: Nov. 25, 2004

(54) Vehicle management system

(76) Inventors: Mahesh Chowdhary, San Jose, CA (US); Gunasekaran Govindarajan, Santa Clara, CA (US)

Correspondence Address: STATTLER JOHANSEN & ADELI, P O BOX 51860, PALO ALTO, CA, 94303

(21) Appl. No.: 10/788,668

(22) Filed: Feb. 27, 2004

Related U.S. Application Data
(60) Provisional application No. 60/450,297, filed on Feb. 27, 2003.

(51) Int. Cl. G06F 17/00

(52) U.S. Cl. 701/1; 340/439

(57) ABSTRACT

A Vehicle Safety Management System (“VSM”) detects safe driving behavior in a vehicle. The system includes a plurality of unsafe driving events, including tailgating, frequent lane changes, speed limit violation, speed limit violation over a curved segment of road, rapid acceleration from a start, and rapid deceleration to a stop. The vehicle is equipped with an event detection module. The event detection module includes a circuit that acquires vehicle data for parameters associated with movement of the vehicle. The event detection module also includes a processor for executing algorithms that determine whether movement of the vehicle meets one or more pre-determined conditions. If the pre-determined conditions are met, event data for one or more unsafe driving events are generated. The event detection module includes a transceiver to send and receive data between the vehicle and a server. The server presents event data to a customer so as to allow the customer to view unsafe driving behavior data for the customer's fleet. For example, the application server may generate reports that detail the unsafe driving events for a driver, vehicle, condition, etc.

### CROSS-REFERENCES TO RELATED APPLICATIONS

This application claims the benefit of U.S. Provisional Patent Application No. 60/450,297, filed Feb. 27, 2003, entitled “Automotive Driver Safety Profile System.”

### BACKGROUND OF THE INVENTION

1. Field of the Invention

The present invention is directed toward the field of automotive safety, and more particularly toward an automotive driver safety profile system.

2. Art Background

A fleet business generally consists of managing numerous motor vehicles. One issue that arises with managing a fleet of vehicles is the constant concern about the well-being of the motor vehicles and their drivers. Specifically, accidents involving fleet vehicles are a major cause of concern. For example, the liability incurred after an accident is typically significant. There may be additional liability incurred if the vehicle involves other drivers and the destruction of personal property outside the fleet. Thus, preventing accidents helps save asset repair costs and reduces insurance premiums. These increases in insurance premiums may be significant. Therefore, driver safety in operating motor vehicles in the fleet becomes a major priority for fleet businesses.

### SUMMARY OF THE INVENTION

A Vehicle Safety Management System (“VSM”) detects safe driving behavior in a vehicle. The system includes a plurality of unsafe driving events. In general, an unsafe driving event characterizes movement of a vehicle in a manner indicative of unsafe driving behavior. In one embodiment, the unsafe driving events include tailgating, frequent lane changes, speed limit violation, speed limit violation over a curved segment of road, rapid acceleration from a start, and rapid deceleration to a stop. The vehicle is equipped with an event detection module. The event detection module includes a circuit that acquires vehicle data for a plurality of parameters associated with movement of the vehicle. For example, in one embodiment, the circuit comprises a plurality of sensors for sensing vehicle movement and/or a global positioning system (“GPS”) receiver. The event detection module also includes a processor for executing algorithms that determine whether movement of the vehicle meets one or more pre-determined conditions. If the pre-determined conditions are met, event data for one or more unsafe driving events are generated.

The event detection module includes a transmitter. In one embodiment, the event data is transmitted from the vehicle to a local server in real time. In another embodiment, the event data is transmitted from the vehicle to a local server at a specified time. For example, the event data may be transmitted to a local server after the vehicle returns to a home base (e.g., a truck returns to a depot station). For this embodiment, the transmitter may comprise a radio transmitter for sending the event data over a wireless connection. The local server comprises, or is coupled to, an application server. In general, the application server presents event data to a customer so as to allow the customer to view unsafe driving behavior data for the customer's fleet. For example, the application server may generate reports that detail the unsafe driving events for a driver, vehicle, condition, etc.

### BRIEF DESCRIPTION OF THE DRAWINGS

FIG. 1 is a block diagram illustrating one embodiment of the VSM system of the present invention.

FIG. 2 is a block diagram illustrating one embodiment for the event detection module.

FIG. 3a is a block diagram illustrating one embodiment for incorporating the event detection module into an AVL System.

FIG. 3b is a block diagram illustrating one embodiment for a stand-alone VSM system.

FIG. 4 is a flow diagram illustrating one embodiment for sensor calibration in the VSM system.

FIG. 5 is a flow diagram illustrating one embodiment for accelerometer calibration in the VSM system.

FIGS. 6a and b are flow diagrams illustrating one embodiment for detecting a tailgating event.

FIGS. 7a and b are flow diagrams illustrating one embodiment for detecting frequent lane changes at high-speed.

FIGS. 8a and 8b are flow diagrams illustrating one embodiment for detecting a speed limit event.

FIGS. 9a and 9b are flow diagrams illustrating one embodiment for detecting curve over speed events.

FIG. 10 is an example screen display for one embodiment of the VSM user interface.

FIG. 11 is an example screen display of a selected Alert/Notification in accordance with one embodiment of the VSM user interface.

FIG. 12 is an example screen display for a Vehicle List in accordance with one embodiment of the VSM user interface.

FIG. 13 illustrates an example screen display for Vehicle Details in accordance with one embodiment of the VSM user interface.

FIG. 14 illustrates an example screen display for a Driver List screen in accordance with one embodiment of the VSM user interface.

FIG. 15 illustrates an example screen display for a Driver Details screen in accordance with one embodiment of the VSM user interface.

FIG. 16 illustrates an example screen display for entering event parameters into the VSM system in accordance with one embodiment of the VSM user interface.

FIGS. 17a and 17b illustrate an example screen display for entering event parameters into the VSM system in accordance with one embodiment of the VSM user interface.

FIG. 18 illustrates an example screen display for a list of communication parameters in accordance with one embodiment of the VSM user interface.

FIG. 19 illustrates an example screen display for communication details of a selected communication parameter in accordance with one embodiment of the VSM user interface.

FIG. 20 illustrates an example screen display for a list of configuration parameters in accordance with one embodiment of the VSM user interface.

FIG. 21 illustrates an example screen display for entering configuration parameter details in accordance with one embodiment of the VSM user interface.

FIG. 22 illustrates an example screen display for a list of reports available in accordance with one embodiment of the VSM user interface.

FIG. 23 illustrates one embodiment for a Total Fleet Safety Historical Report in accordance with one embodiment of the VSM application.

FIG. 24 illustrates one embodiment for a Driver Ranking by Event/Score Report in accordance with one embodiment of the VSM application.

FIG. 25 illustrates one embodiment for a Driver's Performance Report in accordance with one embodiment of the VSM application.

FIG. 26 illustrates an example VSM Event Report for a Frequent Lane Change Violation.

FIG. 27 illustrates an example VSM Event Report for a Tailgating Violation.

FIG. 28 illustrates an example VSM Event Report for a rapid deceleration event.

FIG. 29 illustrates an example VSM Event Report for a rapid acceleration event.

FIG. 30 illustrates an example VSM Event Report for a speed limit violation report.

FIG. 31 illustrates an example VSM Event Report for a curve over speed violation report.

FIG. 32 illustrates one embodiment for a Daily Exception Report in accordance with one embodiment of the VSM application.

FIG. 33 illustrates one embodiment for an Individual Driver Safety Trend Report in accordance with one embodiment of the VSM application.

FIG. 34 illustrates one embodiment for a Driver's Daily Event Report in accordance with one embodiment of the VSM application.

### DETAILED DESCRIPTION

The subject matter of U.S. Provisional Patent Application No. 60/450,297, filed Feb. 27, 2003, entitled “Automotive Driver Safety Profile System” is expressly incorporated herein by reference.

Vehicle Safety Manager System (“VSM”):

In general, the VSM detects and records events that indicate risky driving behavior for a particular type of vehicle. In one embodiment, the VSM system detects the following types of events: tailgating, frequent lane changes at high speeds, driving above the rated speed limit, speeding on a curved road segment, rapid acceleration from a stop, and rapid deceleration to a stop.

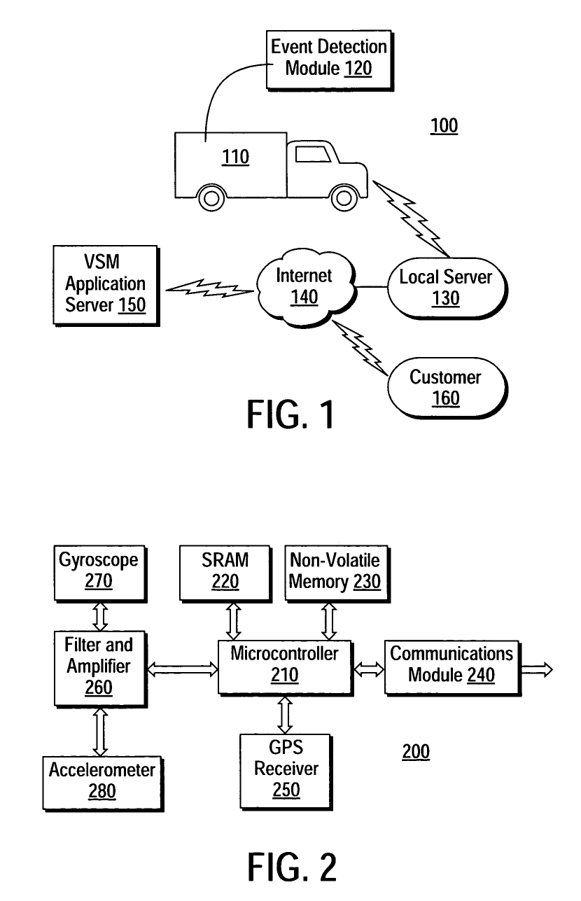

FIG. 1 is a block diagram illustrating one embodiment of the VSM system of the present invention. A vehicle 110 is equipped with the event detection module 120. As described more fully below, the event detection module 120 generates events that indicate risky driving behavior. For this embodiment, the event detection module 120 transmits events to a local server 130. In one embodiment, event detection module 120 transmits events to local server 130 in real time. In another embodiment, the event detection module 120 transmits events to local server 130 when vehicle 110 returns to its depot station. In one embodiment, the events may be processed at local server 130. In other embodiments, event data is transmitted over Internet 140 to VSM system application server 150. VSM system application server 150 processes the event data and generates reports useful for the fleet manager.

In one embodiment, customer computer 160 connects to the VSM system to set parameters and view information about the customer's fleet of vehicles. The customer computer 160 may connect to the VSM application server over a public network, such as the Internet. In another embodiment, the customer computer 160 may connect to a local server. In general, the customer sets parameters for operation of the event detection module 120. In addition, the customer views reports to characterize the driving performance of the customer's fleet. In one embodiment, the VSM application server implements a web site. Through the web site, the customer inputs parameters and receives information about the driving performance of the fleet.

FIG. 2 is a block diagram illustrating one embodiment for the event detection module. For this embodiment, event detection module 200 is operated by micrcontroller 210. Microcontroller 210 operates in conjunction with static random access memory (SRAM) 220 and non-volatile memory 230. The SRAM 220 stores data, during program operation, for microcontroller 210. The non-volatile memory 230 stores data, as well as computer readable instructions, for operation of micrcontroller 210. In one embodiment, nonvolatile memory 230 consists of flash memory. The event detection module includes devices to acquire vehicle position and movement information. For this embodiment, event detection module 200 includes gyroscope 270 and accelerometer 280. Output signals from gyroscope 270 and accelerometer 280 are processed and conditioned through filter and amplifier circuit 260. As described more fully below, gyroscope 270 detects and measures the yaw rate, or angular movement in yaw axis, of the vehicle, and accelerometer 280 detects acceleration/deceleration of the vehicle. A global positioning system (“GPS”) receiver 250 is also integrated into the event detection module 200. In general, the GPS receiver provides data about the vehicle, including position (e.g., latitude, longitude and altitude) vehicle speed and vehicle heading. The event detection module 100 communicates through a communications module 240. For example, for the embodiment of FIG. 1, the event detection module communicates to local server 130 through communications module 240.

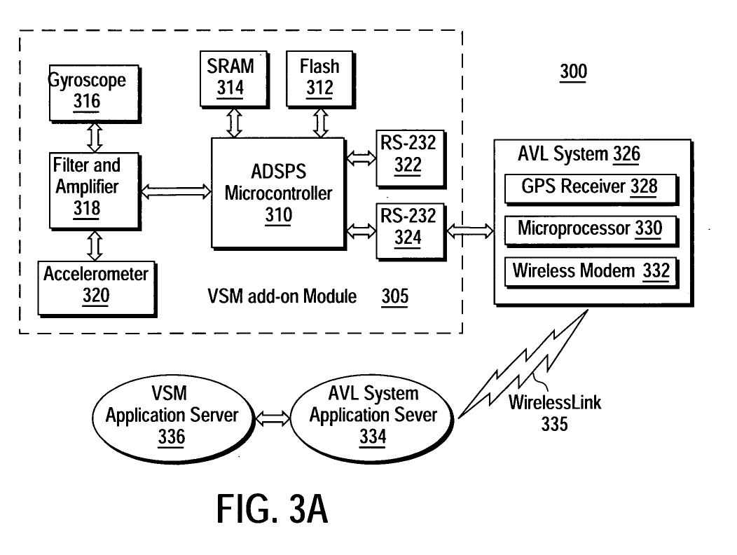

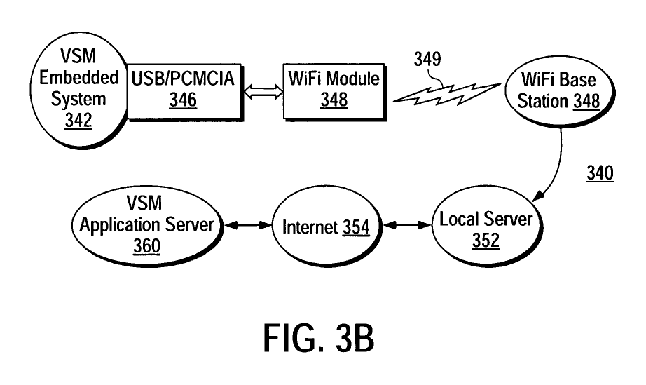

FIG. 3a is a block diagram illustrating one embodiment for incorporating the event detection module into an AVL System. As shown in FIG. 3a, AVL system 326 includes GPS receiver 328, microprocessor 330, and wireless communications modem (e.g., CDPD or GPRS) 332. Similar to the embodiment of the event detection module of FIG. 2, but incorporated as an add-on on module to the AVL system, event detection module includes microcontroller 310, SRAM 314, flash memory 312, gyroscope 316, accelerometer 320, filter and amplifier circuit 318, and a communications ports, configured as RS-232 ports. The event detection add-on module 305 communicates with AVL system 326 through the RS-232 ports. The event detection add-on module 305 receives GPS data, as needed, from the GPS receiver 328 located on the AVL system 328. In operation, event detection add-on module 305 senses data to detect risky driving behavior, and transmits the data to AVL system 326. In turn, AVL system 326 transmits data to AVL system application server 334 through wireless link 335. The AVL system application server communicates with VSM application server 336. In another embodiment, the VSM system transmits event data directly to a VSM application server using TCP/IP protocol. The event detection data is processed for report generation and storage at VSM application server 336. The embodiment of FIG. 3a has the advantage of using the existing infrastructures of the AVL system.

FIG. 3b is a block diagram illustrating one embodiment for a stand-alone VSM system. For this embodiment, the VSM system uses wireless communications to transmit event data from the event detection module to a server. In addition, event detection configuration parameters may be transmitted from a server to the VSM system. Specifically, for this embodiment, the event detection module 342 is coupled to WiFi module 348, using universal serial bus (USB) connection or PCMCIA interface connection 346. In turn, WiFi module 348 communicates to WiFi base station 350, which in turn communicates to local server 352. The local server 352 transmits event data to VSM application server 360 through Internet connection 354.

In one embodiment, the VSM system employs a cost-effective solution by using inexpensive inertial sensors (e.g., gyroscope and accelerometer). However, less expensive sensors require unique sensor calibration strategies. In addition, generating event data with less expensive sensors requires innovative signal filtering and event detection algorithms. Gyroscopes have several characteristics that require an innovative approach to extract a true zero point from the output signal (i.e., a zero point on the output signal indicates zero yaw rate or no angular movement in yaw axis for the vehicle). The zero point output from these gyroscopes drifts with time. In addition, the zero point output is affected by temperature variation. For example, the zero point output may drift with time by as much as 10% of the full-scale. The effective variation with temperature on zero point output may produce a similar variation for every 10 degrees Celsius change in temperature. In order to compensate for this, the gyroscope output must be monitored for bias drift. Thus, the gyroscope is calibrated in order to determine the true zero point output value of yaw rate.

Accelerometers, also used in the event detection hardware, have issues similar to those described above for the gyroscope. For example, the zero point output of an accelerometer varies with time and temperature. Thus, the accelerometer's zero point output must be calibrated during normal course of operation.

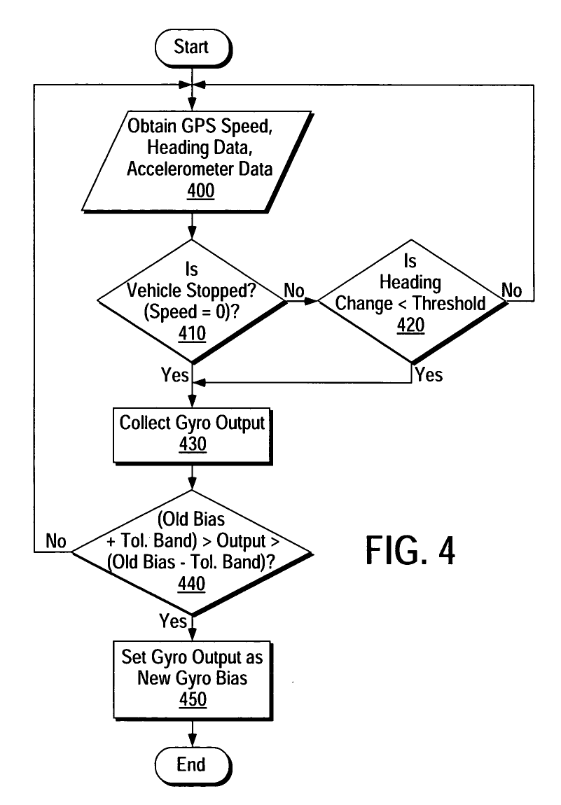

FIG. 4 is a flow diagram illustrating one embodiment for sensor calibration in the VSM system. For this embodiment, the zero point output of the gyroscope is calibrated for bias drift when the vehicle exhibits no angular motion (i.e., the vehicle yaw rate is zero). No angular motion occurs under two vehicle conditions: when the vehicle is stationary or when the vehicle is moving on a straight stretch of the road. Calibration of gyroscope zero point offset is more accurate if the vehicle is stopped. During such conditions, the gyroscope output is monitored for a short fixed period of time. This data is passed through various windowing schemes and the results are compared with previous values of gyroscope zero point output. This process ensures that sudden spurious changes do not corrupt the gyroscope zero point output calibration.

If the vehicle is not stopped but is traveling in a straight line and gyroscope calibration has not been done for a time period longer than a threshold setting, then a second calibration method is used to calibrate the zero point output of the gyroscope. If the vehicle is moving on a straight stretch of road, then the GPS heading data will show no variation. There are two conditions, when observed simultaneously, that determine when the vehicle is traveling in a straight line: 1) when the vehicle heading data does not change above a certain threshold, and 2) when the heading of the various consecutive road segments that vehicle has been driving on indicate that the vehicle is traveling in a straight line. The probability of error is greater when gyroscope calibration is done when the vehicle is in motion. In one embodiment, additional tests are conducted prior to calibrating the gyroscope under this method. For example, one test may include calculating the difference between the new zero point value and the old zero point and comparing the difference to a threshold. Another test may include comparing the new zero point value to prior recorded zero point values to determine whether the new zero point deviates substantially from the prior recorded zero point values.

This process of gyroscope calibration is illustrated in the flow diagram of FIG. 4. GPS speed data, GPS heading data and accelerometer data are obtained (block 400, FIG. 4). In one embodiment, the system has access to GPS position, speed and heading data. Also, the system has access to the on-board map database. The GPS speed data may be used to determine whether the vehicle is stationary. If the vehicle is not stopped, and the heading change is less than a threshold (i.e., to indicate that vehicle is traveling on a straight stretch of road), then gyroscope output data is collected. (blocks 410, 420 and 430, FIG. 4). Alternatively, if the vehicle is not stopped and the heading change is greater than the threshold, then a new set of GPS speed data, heading data, and accelerometer data is obtained (blocks 410, 420 and 430, FIG. 4). If the vehicle is stopped, then the gyroscope output data is collected (blocks 410 and 430, FIG. 4). The output data from the gyroscope is analyzed to determine whether it is a spurious value. Specifically, the output is compared against the old bias plus the tolerance band and the old value minus the tolerance band (block 440, FIG. 4). If the new output data from the gyroscope falls within this range, then the gyroscope output data is set as the new gyroscope bias (block 450, FIG. 4).

The gyroscope output data, measured in volts, is converted into angular rate (degrees per second of rotation) using a prescribed value of sensor sensitivity and a scaling factor. When the vehicle makes a turn, the change in heading, as observed by integrating the gyroscope output, is compared with an actual amount of turning. In one embodiment, the actual amount of turning is traced on the digital geographical map database interfaced with the VSM system. This comparison is used to calibrate the gyroscope sensitivity scale factor.

The accelerometer is calibrated when the vehicle is stopped. In addition, the two axes of the accelerometer are put in a level plane at the time of calibration. There are two vehicle conditions when this condition occurs: when the vehicle is stationary and is parked level such that gravity does not affect the accelerometer. In one embodiment, GPS data may be used to determine whether the vehicle is stationary. In order to determine whether the accelerometer is positioned in a level plane perpendicular to gravity, the data from both axes of the accelerometer (i.e., longitudinal and lateral) is correlated. Since a two axes accelerometer is used, the gravity component is feed into both axes. Generally, the accelerometer zero point value does not drift more than 1% within a couple of hours. If the time since last calibration has not been very long and a new zero point value lies outside a tolerance band from the previous zero point value, only a fraction of the difference is applied to obtain a new zero point value. If the accelerometer calibration has not happened for a couple of hours during freeway driving, the tolerance band could be 0.02*G. This process prevents updating the zero point value with a large incorrect value due to an inclination of the vehicle.

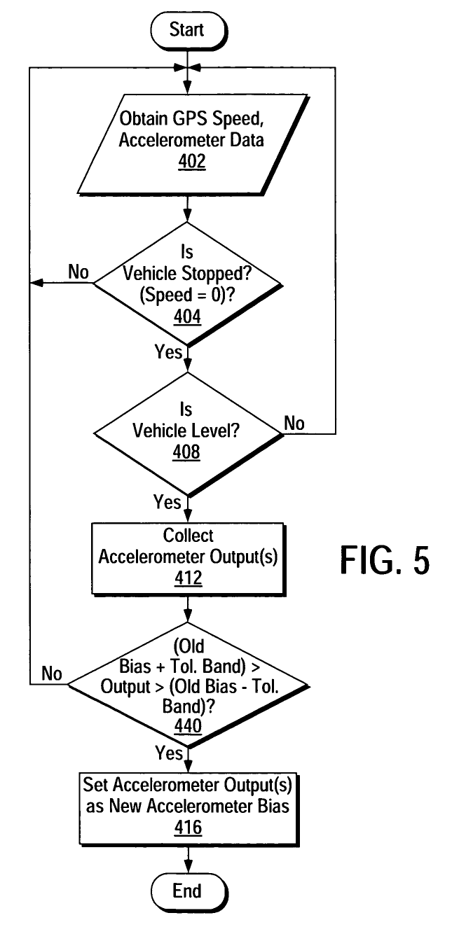

FIG. 5 is a flow diagram illustrating on embodiment for accelerometer calibration. GPS speed data and accelerometer data are obtained (block 402, FIG. 5). The GPS speed data may be used to determine whether the vehicle is stationary. If the vehicle is stopped, then both axes of the accelerometer are correlated to determine whether the vehicle is level (block 408, FIG. 5). If the vehicle is level, then accelerometer output data is collected. (blocks 412, FIG. 5). Alternatively, if the vehicle is not stopped and/or the vehicle is not level, then a new set of GPS speed data and accelerometer data is obtained. The output data from the accelerometers is analyzed to determine whether it is erroneously affected by gravity. Specifically, the output is compared against the old bias plus the tolerance band and the old value minus the tolerance band (block 440, FIG. 5). If so, the new output values from the accelerometer are set as the new accelerometer biases (block 416, FIG. 5).

Vehicle Safety Management Events:

Tailgating Event:

In one embodiment, the VSM system detects tailgating as an event. During a tailgating condition, a vehicle follows another vehicle too closely, typically at high-speeds, and for a substantial period of time (e.g., usually for more than several minutes). In one embodiment, the VSM system determines a tailgating event based on rapid acceleration/deceleration. This type of driving pattern is typical of a vehicle following another vehicle very closely and at high-speeds. The acceleration profile of longitudinal axis contains the information to determine rapid acceleration/deceleration experienced during the tailgating condition. The longitudinal acceleration, filtered with a low pass filter, is processed to extract points of inflexion (i.e., when the slope of acceleration data is zero), slope between inflexion points, the values at inflexion points, and time separations between inflexion points. Then, the slopes of acceleration data between the inflexion points are compared with the threshold value of acceleration for a particular vehicle type (e.g., car, light truck, or semi tractor trailer). In one embodiment, to calculate the slope (or gradient), acceleration/deceleration data point, P1, which has a value and time, is recorded at the start of data collection and another point, P2, is recorded after a fixed time period (e.g. 100 milliseconds). Then,

Slope=(A_{@P2}−A_{@P1})/(0.100).

If slope exceeds the threshold value, then monitoring for a tailgating event begins. In another embodiment, the current value of acceleration/deceleration is compared to the threshold value for acceleration/deceleration to detect a tailgating event. The process of collecting data for tailgating event detection starts when the acceleration is above 0.04 g or deceleration is −0.07 g. The threshold value for acceleration is 0.20 g and the threshold value for deceleration is −0.23 g for a 14 ton truck. The peak value of acceleration or deceleration at an inflexion point and the separation time between inflexion points are used to determine the severity of the tailgating event. In one embodiment, to calculate the severity of the tailgating event, the maximum value of acceleration or deceleration detected during the tailgating event is determined. Also, the peak vehicle speed recorded during the tailgating event is determined. Then, the absolute maximum value of acceleration (or deceleration) is divided by a vehicle specific value for acceleration (e.g., the value is 0.3 G for a 14 ton truck) to obtain S1. The peak speed detected during the tailgating event is divided by vehicle specific value (e.g. the value of 65 mph for a 14 ton truck) to obtain S2. The severity is then calculated as:

Severity=0.65*S1+0.35*S2.

In another method, the smallest amount of time between any two consecutive acceleration/deceleration events could also be used. The smallest time difference between two lane change occurrences is divided by a vehicle specific value (e.g. the value of 3 minutes for a 14 ton truck) to obtain S3. The severity in this case is calculated as:

Severity=0.5*S1+0.25*S2+0.25*S3

The vehicle's speed is determined by integrating longitudinal acceleration and by monitoring the integration process using GPS speed as an input.

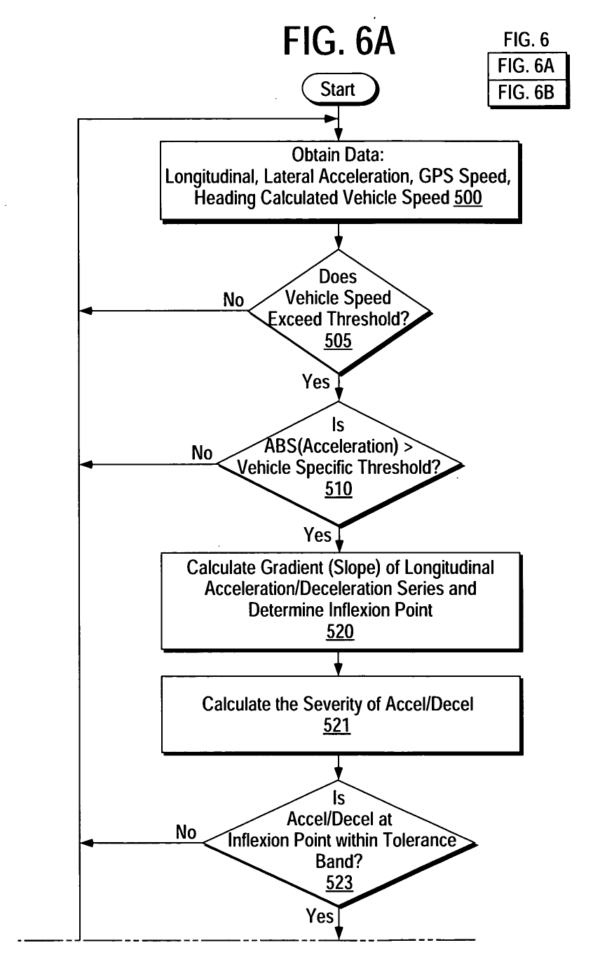

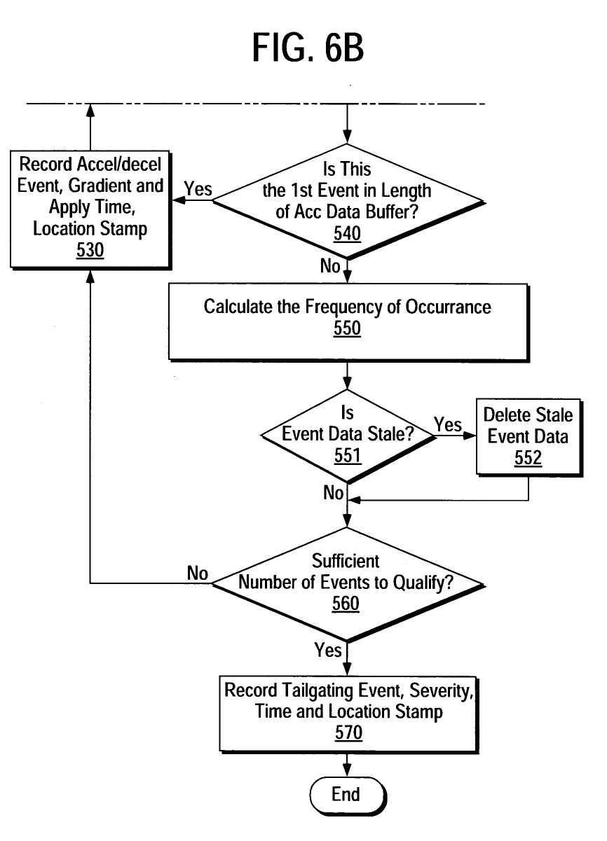

FIGS. 6a and 6b are flow diagrams illustrating one embodiment for detecting a tailgating event. Longitudinal and lateral acceleration, GPS speed and heading and calculated vehicle speed are obtained (block 500, FIG. 6a). If the vehicle exceeds a threshold speed, then the data obtained is used to begin determining whether a tailgating event has occurred (block 505, FIG. 6a). In one embodiment, the default threshold speed is set to 5 mph. The user may set the threshold speed between the range of 0 and 20 mph. If the absolute value of the vehicle acceleration is greater than the vehicle specific threshold, then the VSM system calculates a gradient of longitudinal acceleration/deceleration series and determines the inflexion point(s) (block 510 and 520, FIG. 6a). If the absolute value of the vehicle acceleration is less than a vehicle specific threshold, then new data is obtained (blocks 510 and 500, FIG. 6a). The VSM system determines whether the acceleration/deceleration at the inflexion point is within a tolerance band (block 523, FIG. 6a). If the inflexion point is within a tolerance band, then the severity of the acceleration/deceleration is calculated (block 521, FIG. 6a). The severity of acceleration/deceleration is calculated by dividing the peak value of acceleration/deceleration at the inflexion point by the vehicle specific value (e.g. the value of 0.3G for a 14 ton truck). If not, then new data is obtained (blocks 523 and 500, FIG. 6a).

If this is the first acceleration/deceleration event detected, then the event is recorded, along with the gradient, time (date, hour, minute and second) and location stamp (latitude, longitude of the location) (blocks 540 and 530, FIG. 6b). If this is not the first acceleration/deceleration event detected, then the frequency of occurrence is calculated (blocks 540 and 550, FIG. 6b). The VSM system determines whether any events in the Acceleration/Deceleration buffer are stale (block 551, FIG. 6b). If any of the events in the buffer are stale, the stale events are discarded (blocks 551 and 552, FIG. 6b). Then, the VSM system determines whether there are a sufficient number of buffer events to qualify (block 560, FIG. 6b). If there are a sufficient number of entries in the buffer, then the tailgating event, along with the severity, time and location stamp, are recorded (block 570, FIG. 6b). If there are not a sufficient number of entries in the buffer, then new data is obtained (block 560, FIG. 6b).

Frequent Lane Change Event:

In one embodiment, the VSM system detects frequent lane changes at high-speed as an event. Frequent lane changes at high speed are associated with rapid change in vehicle heading in a short period of time. The gyroscope detects angular rate for yaw axis of the vehicle. This angular rate corresponds to vehicle heading changes. The angular rate is filtered, using a low pass filter, and processed to extract points of inflexion, slope between inflexion points, peak values at inflexion points, and time separations between inflexion points. The slope of the angular rate may be used to detect a lane change event. In another embodiment, instead of using slope, the current value of the yaw rate is compared to the threshold value of yaw rate for lane change events to detect a lane change event. Frequency of such events, combined with the speed of the vehicle at that time, may be used to determine the severity of the incident.

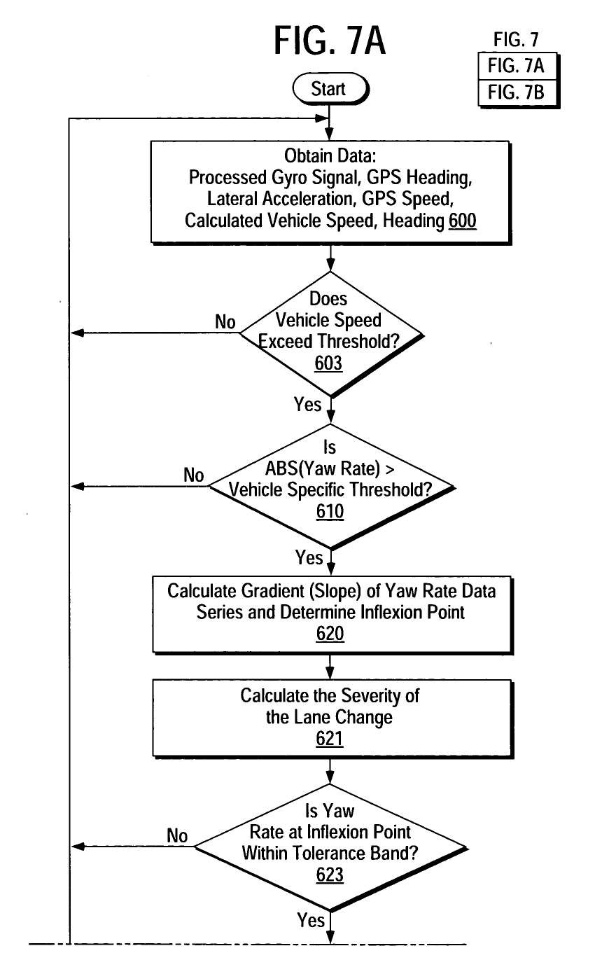

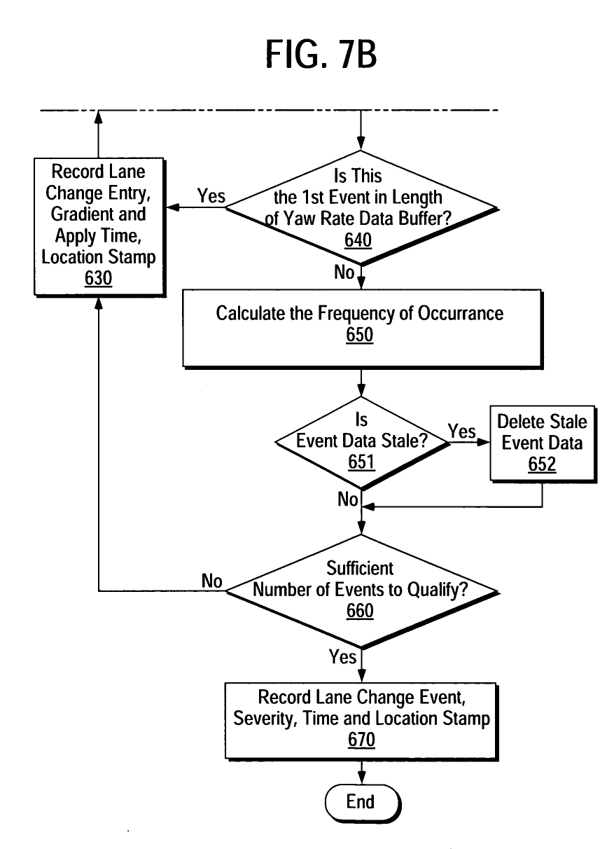

FIG. 7a and 7b are flow diagrams illustrating one embodiment for detecting frequent lane changes at high-speed. Processed gyroscope signal, GPS heading, lateral acceleration, GPS speed, and calculated vehicle speed and heading are obtained (block 600, FIG. 7a). If the vehicle exceeds a threshold speed, then the data obtained is used to begin determining whether a frequent lane change event has occurred (block 603, FIG. 7a). In one embodiment, the default threshold speed is set to 25 mph. The user may set the threshold speed between the range of 0 and 40 mph. If the absolute value of the yaw rate is not greater than the vehicle specific threshold, then new data is obtained (blocks 610 and 600, FIG. 7a). In one embodiment, the yaw rate of 0.6 degree/sec is a threshold number used for a 14 ton truck. If the absolute value of the yaw rate is greater than the vehicle specific threshold, then the VSM system calculates the gradient of a yaw rate data series and determines the value at the inflexion point(s) (blocks 610 and 620, FIG. 7a). In one embodiment, to calculate the gradient, yaw rate data point, P1, which has a value and time, is recorded at the start of data collection and another point, P2, is recorded at the peak value (or inflexion point) of the yaw rate. Then,

Gradient=(yaw rate at P2−yaw rate at P1)/(time at P2−time at P1).

The VSM system determines whether the yaw rate at the inflexion points is within a tolerance band (block 623, FIG. 7a). The tolerance band is set to detect vehicle rotation indicative of a lane change. A road may be curved. As a vehicle travels over the curved road, the event detection module detects the rotation of the vehicle as it follows the curved road. However, roads are designed such that the vehicle does not have to go through a rapid change in vehicle heading in a very short amount of time. Thus, the minimum tolerance, for both magnitude and time, of the yaw rate gradient differentiates between a vehicle changing lanes and a vehicle traveling along a curved road. The maximum level on the tolerance band eliminates events that indicate the yaw rate gradient of the vehicle is too large, such as a vehicle making a U-turn. In one embodiment, the tolerance band for elapsed time between yaw rate data points is not more than 1.1 seconds and not less than 0.1 second. The tolerance band for the magnitude of a yaw rate data point is between 2 degree/second and 0.3 degree/second.

If the yaw rate at the inflexion points is within a tolerance band, then the severity of the lane change is calculated (block 621, FIG. 7a). In one embodiment, to calculate the severity of the lane change event, the maximum value of the yaw rate, either for a left turn or a right turn, out of the lane change events is calculated. Also, the smallest amount of time between any two lane change events is detected. Then, the maximum yaw rate is divided by a vehicle specific maximum yaw rate value to obtain S1. The smallest time difference between two lane change occurrences is divided by a vehicle specific value to obtain S2. The severity is then calculated as:

Severity=0.6*S1+0.4*S2.

In another method, the peak speed of the vehicle during the frequent lane change event may also be used. The peak speed of the vehicle is divided by a vehicle specific value to obtain S3. The severity in this case is calculated as:

Severity=0.5*S1+0.25*S2+0.25*S3

If the lane change event is the first event in the event buffer, then the lane change entry, including gradient, time and location stamps (latitude and longitude of location), are recorded in the data buffer (blocks 640 and 630, FIG. 7b). If this is not the first yaw rate event, then the VSM system calculates the frequency of occurrence (blocks 650, FIG. 7b). If any of the events are stale, then the stale events are deleted (blocks 651 and 652, FIG. 7b). The VSM system determines whether there are a sufficient number of events to qualify (block 660, FIG. 7b). If there are a sufficient number of entries in the event data buffer, then the lane change event, along with the severity, time and location stamp, are recorded (block 670, FIG. 7b). If there are not a sufficient number of entries in the buffer, then the lane change entry, including gradient, time and location stamps (latitude and longitude of location), is recorded in the data buffer, and new data is obtained (block 630, FIG. 7b).

Speed Over Limit Event:

In one embodiment, the VSM system also determines, as an event, driving above the rated speed limit. The vehicle's speed may be obtained from GPS speed data. If GPS signal data is not available, then the vehicle's speed may be obtained by integrating processed longitudinal acceleration data obtained from the accelerometer. A digital geographical map database is used to position the vehicle's current location on the road segment in the map database. The vehicle's current location, heading, GPS heading and the distances to various nearby road segments are used to determine the best fit for the road segment in the digital map database. The rated speed limit of the road segment is available from the map database. The current speed of the vehicle is compared against the rated speed limit to detect a speeding event.

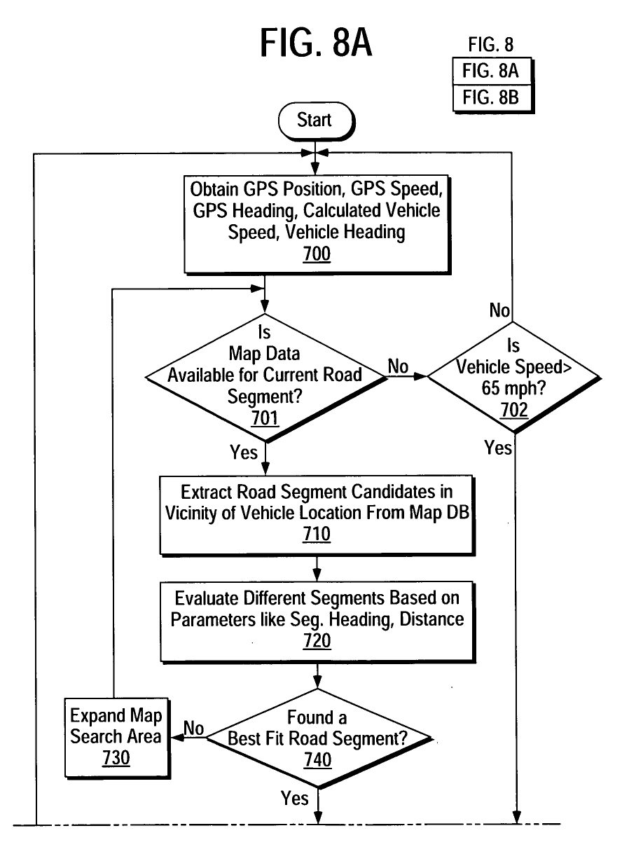

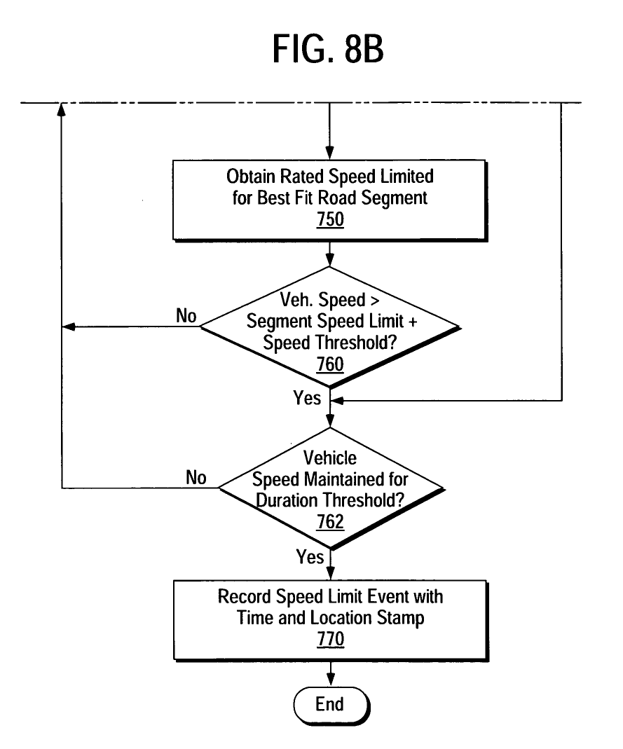

FIGS. 8a and 8b are flow diagrams illustrating one embodiment for detecting a speed limit event. First, the VSM system obtains data, including GPS position, GPS speed, GPS heading, calculated vehicle speed, and vehicle heading (block 700, FIG. 8a). The VSM system determines whether digital map data is available for the current road segment (block 701, FIG. 8a). If the map data is available, then the VSM system extracts road segment candidates from the digital map database in the vicinity of the vehicle location (block 710, FIG. 8a). The VSM system evaluates different segments based on parameters, such as segment heading and distance. If the VSM system finds a best-fit road segment, then the rated speed limit for the best-fit road segment is obtained (blocks 740 and 750, FIGS. 8a & 8b). If a best-fit road segment is not found, then the digital map database search area is expanded, and additional road segment candidates are identified (blocks 740, 730, 710 and 720, FIG. 8a).

In one embodiment, a speed threshold parameter is used. The vehicle speed must exceed the segment speed limit by the speed threshold parameter. In one embodiment, the speed threshold parameter is set to a default of 5 mph for a highway and is set to 2 mph for a city street. The user may define the threshold parameter within the range of 0 to 20 mph for a highway and 0 to 15 mph for a city street. If the best-fit road segment and rated speed limit for the best road segment have been obtained, the vehicle's speed is compared with the segment speed limit plus the speed threshold.

If the vehicle's speed is greater than the segment speed limit by at least the speed threshold, then the VSM system determines whether the speed has been maintained for a duration threshold (blocks 760 and 762, FIG. 8b). If the vehicle speed is less than the segment speed limit plus the speed threshold, then new data is obtained to determine another speed limit violation event (blocks 760 and 700, FIGS. 8a & 8b). Also, if no map data is available and the vehicle speed exceeds 65 mph, then the VSM system also determines whether the speed has been maintained for a duration threshold (blocks 701, 702 and 762, FIGS. 8a & 8b). In one embodiment, the time duration is set to a default of 1 minute for a highway and is set to 10 seconds for a city street. The user may define the time duration within the range of 0 to 5 minutes for a highway and 0 to 60 seconds for a city street. If the speed has been maintained for the duration threshold, then a speed limit event, with time and location stamps (latitude and longitude of location), are recorded (blocks 762 and 770, FIG. 8b). If the speed has not been maintained for the duration threshold, then new data is obtained to determine another speed limit violation event (blocks 762 and 700, FIGS. 8a & 8b).

Speeding on a Curved Road Segment Event:

In one embodiment, the VSM system detects speeding on a curved road segment as an event. The digital geographical map database contains information on road segment geometry and advisory speed limit for curved road segments. If the advisory speed limit for a curved road segment of interest is not available, a good estimate may be calculated. The maximum safe speed to negotiate a curve road segment depends upon the minimum radius of curvature, side friction coefficient of the pavement, and super-elevation (i.e., banking of the road). The radius of curvature for a road segment is available from the geographical map database. Also, the United States Department of Transportation guidelines, used for road construction, may be used to estimate side friction coefficient and super-elevation for a known value of road segment radius of curvature. The maximum safe speed for a curved road segment can be calculated from

V_{c}=Sqrt[Rg(e+f)]

wherein,

R=radius of curvature of the road segment,

e=super-elevation (banking)

f=maximum value of coefficient of side friction

g=gravitational acceleration.

The vehicle's speed is compared to the prescribed fraction, depending on the type of vehicle, of the maximum safe speed for a road segment to detect the speeding on a curved road segment event. The value of lateral acceleration, observed during the process the speeding over the curved road segment, may be used to determine the severity of the incident.

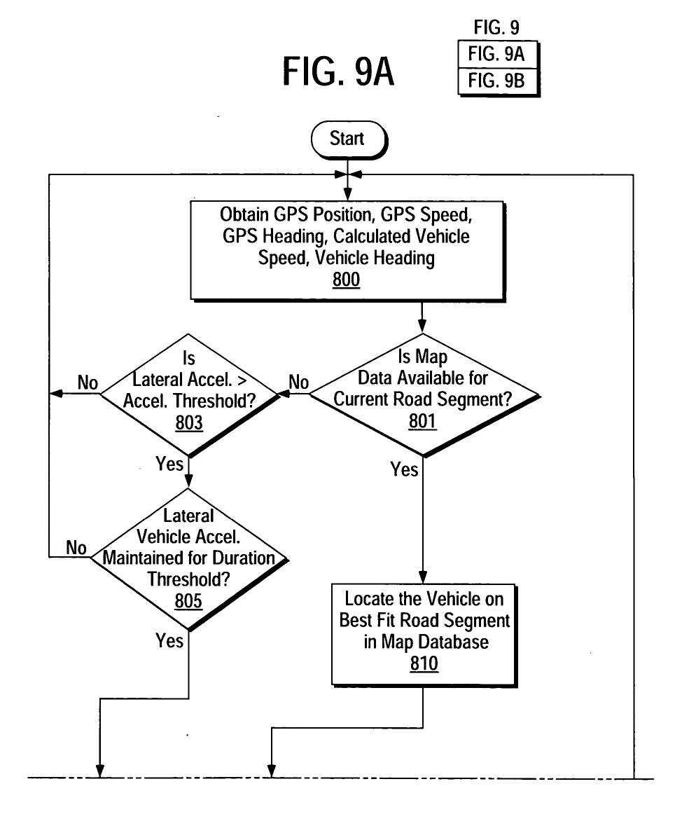

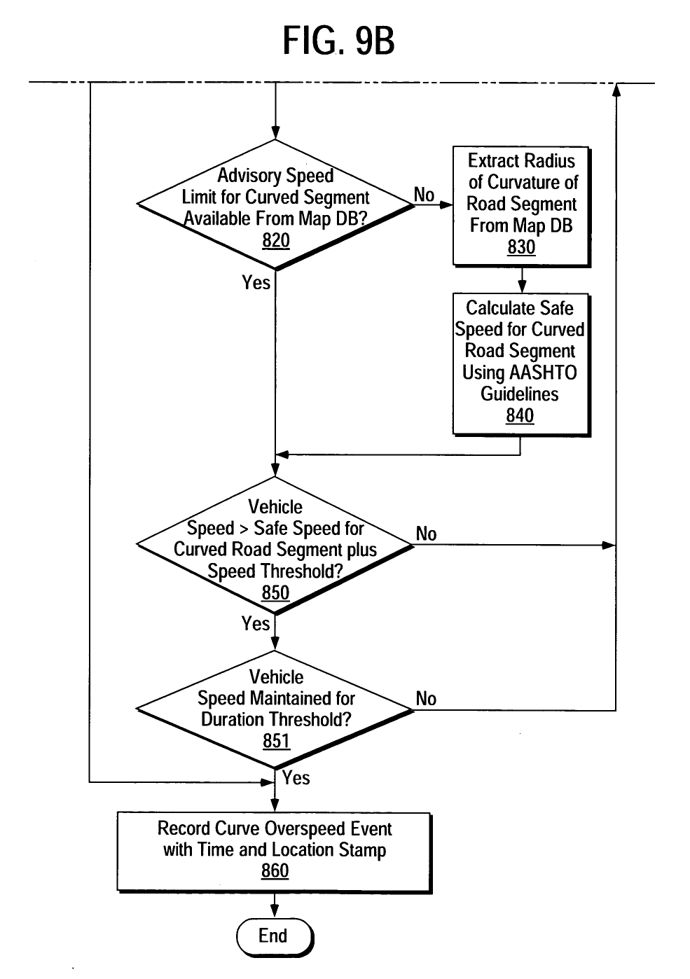

FIGS. 9a and 9b are flow diagrams illustrating one embodiment for detecting curve over speed events. Data is obtained, including GPS position, GPS speed, GPS heading, calculated vehicle speed and vehicle heading (block 800, FIG. 9a). The VSM system determines whether digital map data is available for the current road segment (block 801, FIG. 9a). If the map data is available, then the vehicle is located on a best-fit road segment in the map database (block 810, FIG. 9a). If the advisory speed limit for the curve segment is not available from the map database, then the radius of curvature of the road segment is extracted from the map database (blocks 820 and 830, FIG. 9b). Then, the safe speed for a curved road segment using AASHTO guidelines, as discussed above, is calculated (block 840, FIG. 9b). If the vehicle speed limit for the curved road segment is available from the map database or the speed limit was calculated as described above, then the vehicle's speed is compared with the safe speed for the curved road segment plus a speed threshold (block 850, FIG. 9b). The speed threshold parameter is used such that the vehicle speed must exceed the vehicle speed limit for the curved road segment by the speed threshold parameter. In one embodiment, the threshold parameter is set to a default of 5 mph. The user may define the threshold parameter within the range of 0 to 20 mph.

If the vehicle speed stays above the maximum safe speed for the curved segment by the speed threshold more than a user defined time duration, then a curve over-speed event is generated (block 850 and 851, FIG. 9b). The curve over speed event, with time and location stamps, is recorded (block 860, FIG. 9b). In one embodiment, the time duration threshold is set to a default of 4 seconds. The user may define the time duration within the range of 0 to 10 seconds. If the vehicle speed does not stay above the maximum safe speed for the curved segment by the speed threshold more than a user defined time duration, then new data is obtained (blocks 851 and 800, FIG. 9b).

If no map data is available, then the VSM system determines whether the lateral acceleration is greater than an acceleration threshold (e.g., 0.06 g) (blocks 801 and 803, FIG. 9a). If it is not, then new data is obtained (blocks 803 and 800, FIG. 9a). If the lateral acceleration is greater than the acceleration threshold, then VSM system determines whether the lateral acceleration has been maintained for a duration threshold (blocks 803 and 805, FIG. 9a). If it has, then the curve over speed event, with time and location stamps, is recorded (block 860, FIG. 9b). If the lateral acceleration has not been maintained for a duration threshold, then new data is obtained (block 805 and 800, FIG. 9a).

Rapid Acceleration from a Stop Event:

In one embodiment, the VSM system also determines repeated rapid accelerations from a stop as an event. The slope of processed longitudinal acceleration may be used to determine how fast the vehicle is accelerating. In another embodiment, the filtered value of longitudinal acceleration is monitored. The current value of acceleration is compared with a user defined maximum allowable acceleration threshold to identify rapid acceleration events. In one embodiment, the default acceleration threshold parameter is set to 0.15 g. The user may specify the acceleration threshold parameter to lie within the range of 0.1 g to 0.4 g. In order to generate an event, a time period for the rapid vehicle acceleration must exceed a duration threshold. In one embodiment, the default duration threshold is set to 1.5 seconds. The user may specify the duration threshold to lie within the range of 1 to 4 seconds. The peak value at the inflexion point and duration of acceleration is used to determine the severity of the incident. The peak acceleration value is divided by a vehicle specific value (e.g., 0.4 g for a 14 ton truck) to obtain S1. The duration of acceleration event is divided by a vehicle specific value (e.g., 4 seconds for a 14 ton truck) to obtain S2. The severity of the event is calculated as:

Severity=0.7*S1+0.3*S2.

Rapid Deceleration to a Stop Event:

In one embodiment, the VSM system also determines repeated rapid decelerations to a stop as an event. Similar to a rapid acceleration event, the slope of processed longitudinal acceleration may be used to determine how fast the vehicle is decelerating. The current value of deceleration is compared with a user defined maximum allowable deceleration threshold to identify a rapid deceleration event. The current value of deceleration is compared with a user defined maximum allowable deceleration threshold to identify rapid deceleration events. In one embodiment, the default deceleration threshold parameter is set to 0.18 g. The user may specify the deceleration threshold parameter to lie within the range of 0.1 g to 0.65 g. In order to generate an event, a time period for the vehicle deceleration must exceed a duration threshold. In one embodiment, the default duration threshold is set to 1 second. The user may specify the duration threshold to lie within the range of 0.7 to 4 seconds. The maximum value of deceleration observed and time elapsed between multiple events is used to determine the severity of the incident. The peak acceleration value is divided by a vehicle specific value (e.g., 0.4 g for a 14 ton truck) to obtain S1. The duration of acceleration event is divided by a vehicle specific value (e.g., 4 seconds for a 14 ton truck) to obtain S2. The severity of the event is calculated as:

Severity=0.7*S1+0.3*S2

Vehicle Management System Application:

The VSM application server (150 FIG. 1, 336 FIG. 3A, and 360 FIG. 3B) implements an application for the vehicle management system. For example, as described more fully below, the VSM application generates reports to characterize various driving parameters for a fleet. In addition, the VSM application includes a user interface. The VSM user interface provides a means for a user (e.g., fleet manager) to set-up parameters and view information about the system. In one embodiment, the VSM application implements the VSM user interface through a web site. The web site is accessible through a public network, such as the Internet. However, in other embodiments, the user may access the VSM user interface over a private network. The user accesses the VSM user interface to set-up parameters and to view information about the system. In one embodiment, the VSM application includes a login screen. The user enters a user name (e.g., customer fleet name) and password, and the VSM application authenticates the user. Once customer verification has occurred, a user is permitted to set-up parameters and view data for that customer.

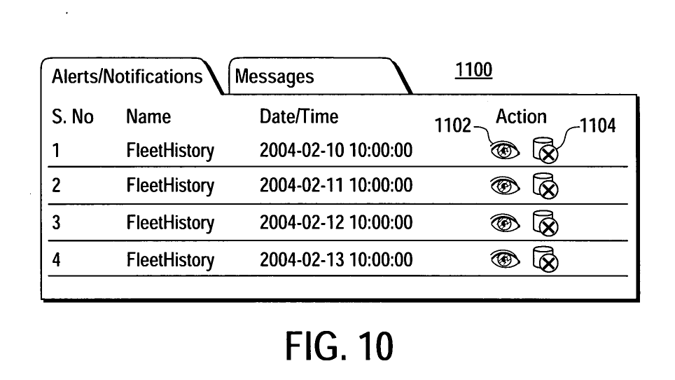

FIG. 10 is an example screen display for one embodiment of the VSM user interface. For this embodiment, a home page displays an “Alert/Notifications” and “Messages” screen. A user may set the Alerts/Notification to generate various reports of particular concern to that user. For this example, the “Alerts/Notifications” lists a “Fleet Safety Historical Report” for several days (e.g., Feb 10-Feb 13). As shown in FIG. 10, the Alert/Notifications screen displays the name of the report (e.g., Fleet History), the date and time of the report, and action icons. For example, action icon 1102, when selected, results in display of the corresponding report. The VSM application erases a corresponding Alerts/Notifications when icon 1104 is selected.

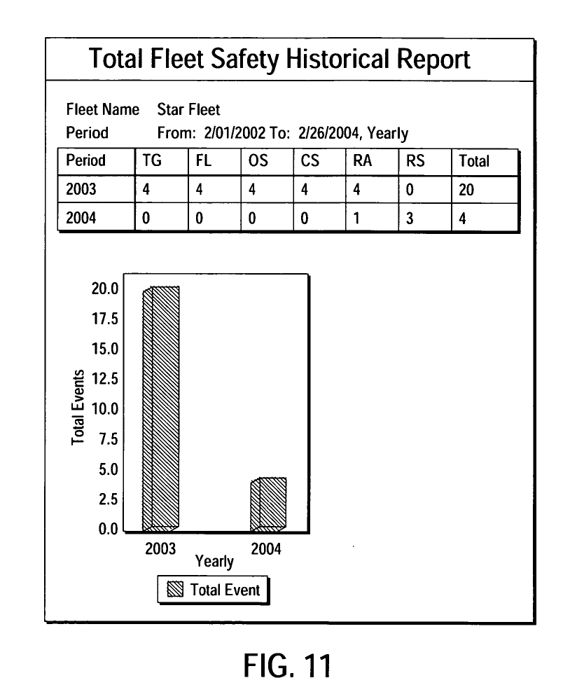

If a user selects icon 1102 for an Alerts/Notification, details of the Alerts/Notification are displayed. FIG. 11 is an example screen display of a selected Alert/Notification in accordance with one embodiment of the VSM user interface. For this example, the VSM user interface displays a “Total Fleet Safety Historical Report.” This report shows, for the customer fleet, the number of individual events and the total number of events for a time period (e.g., annual). The abbreviations for the events are as follows: TG—tailgating event; FL—frequent lane change event; OS—over speed limit event; CS—speed limit over curve road segment event; RA—rapid acceleration; and RS—rapid deceleration. For this example report, a total of 20 unsafe driving events occurred in 2003. The screen display of FIG. 11 also displays a graph that depicts the total number of events per a specified year.

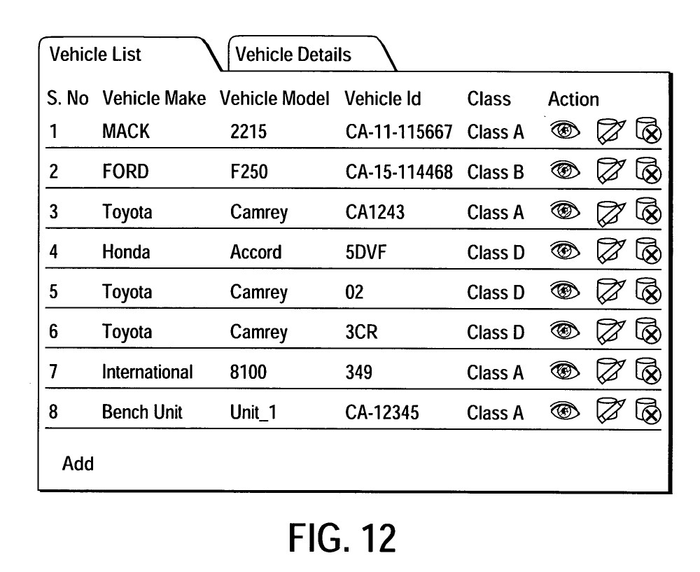

In one embodiment, the home page of the VSM user interface includes a selection for “Vehicles.” The vehicle selection includes a “Vehicle List” and “Vehicle Details.” FIG. 12 is an example screen display for a Vehicle List in accordance with one embodiment of the VSM user interface. For this embodiment, the VSM application displays a list of vehicles in the customer's fleet. The user may associate each vehicle with a class. In addition to the vehicle class, the Vehicle List displays, for each vehicle listed, the vehicle make, vehicle model and vehicle identification. In addition, the action icons, displayed to the right of each vehicle listed, permits a user to view vehicle details, save vehicle details and delete a vehicle.

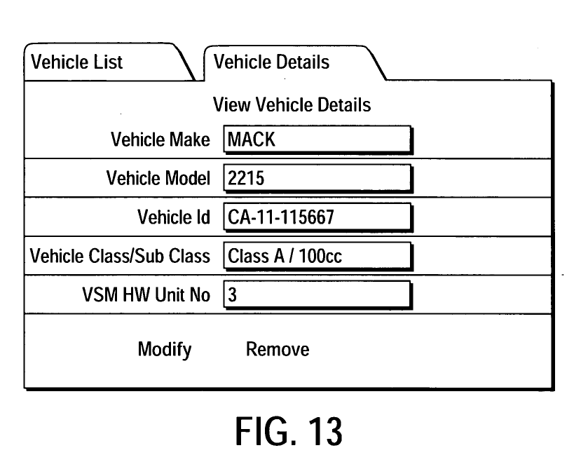

If a user selects to view vehicle details, a screen, which allows a user to edit the vehicle details, is displayed. FIG. 13 illustrates an example screen display for Vehicle Details in accordance with one embodiment of the VSM user interface. As shown in FIG. 13, vehicle details for a selected vehicle are shown (e.g., Vehicle Make, Vehicle Model, Vehicle Id, Vehicle Class/Sub Class, and a VSM hardware unit number). The VSM hardware unit number identifies the event detection module in the vehicle. From the Vehicle Details screen, the user is permitted to enter and edit the fields of Vehicle Details.

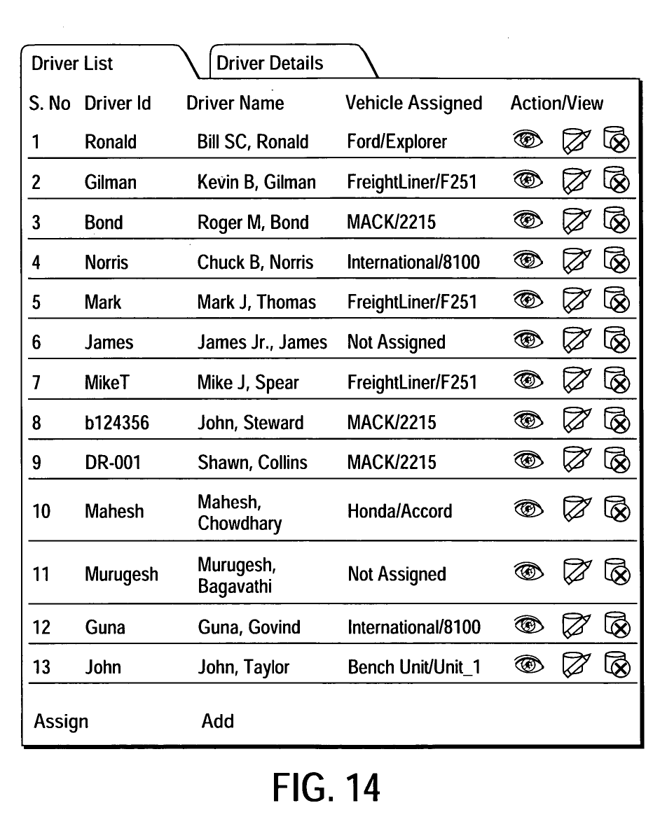

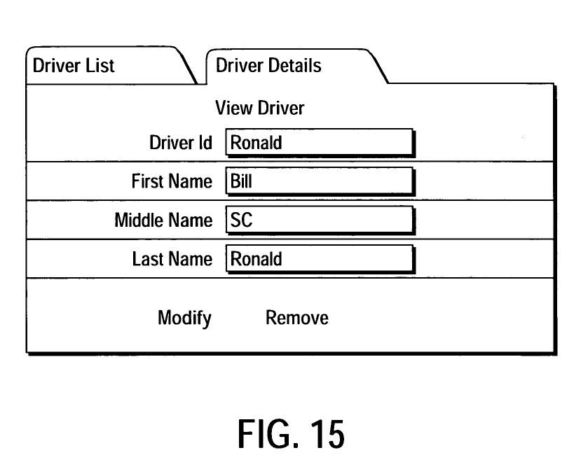

In one embodiment, the home page of the VSM user interface includes a selection for “Drivers.” The “Drivers” portion of the user interface includes a “Driver List” and “Driver Details.” FIG. 14 illustrates an example screen display for a Driver List screen in accordance with one embodiment of the VSM user interface. The “Driver List” display lists all of the drivers associated with the customer. In addition to the driver's name, a driver id and assigned vehicle is associated with each driver. For example, a Mack/2215 has been assigned to Roger Bond. From the Driver List display, a user may view details of a driver, save the driver information, or delete the driver from the driver list. A user may also add a new driver to the list. If the user selects to view driver details, a driver detail screen is displayed.” The “Drivers” portion of the user interface includes a “Driver List” and “Driver Details.” FIG. 15 illustrates an example screen display for a Driver Details screen in accordance with one embodiment of the VSM user interface. For this example, driver details for “Bill Ronald” are displayed. From this screen, a user may modify or edit the driver information or the user may remove the driver from the driver list.

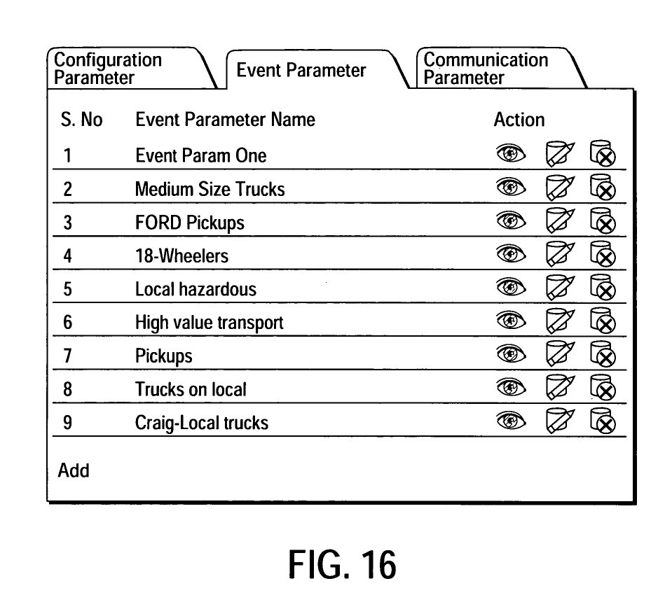

In one embodiment, the home page of the VSM user interface includes a selection for “VSM Hardware Configuration.” From this set of screen displays, the user is permitted to set parameters related to both event and notification generation in the VSM system. FIG. 16 illustrates an example screen display for entering event parameters into the VSM system in accordance with one embodiment of the VSM user interface. As discussed above, event parameters are user defined values that dictate the conditions for generating an event. For example, one event parameter allows a user to define a minimum speed over a speed limit that a vehicle must exceed to generate an speed limit violation event. In one embodiment, the user of the VSM system may create categories to set event parameters. The safe operation of a vehicle may be dependent upon a number of factors (i.e., type of vehicle, area driven, etc.). For example, as shown in FIG. 16, a user may create an event category for “Medium Size Trucks.” This permits the user to set event parameters for all trucks, classified as medium sized trucks, through the Medium Size Trucks parameter. The screen of FIG. 16 lists the event parameter names for the customer. The user may view details, as well as add and delete event parameters.

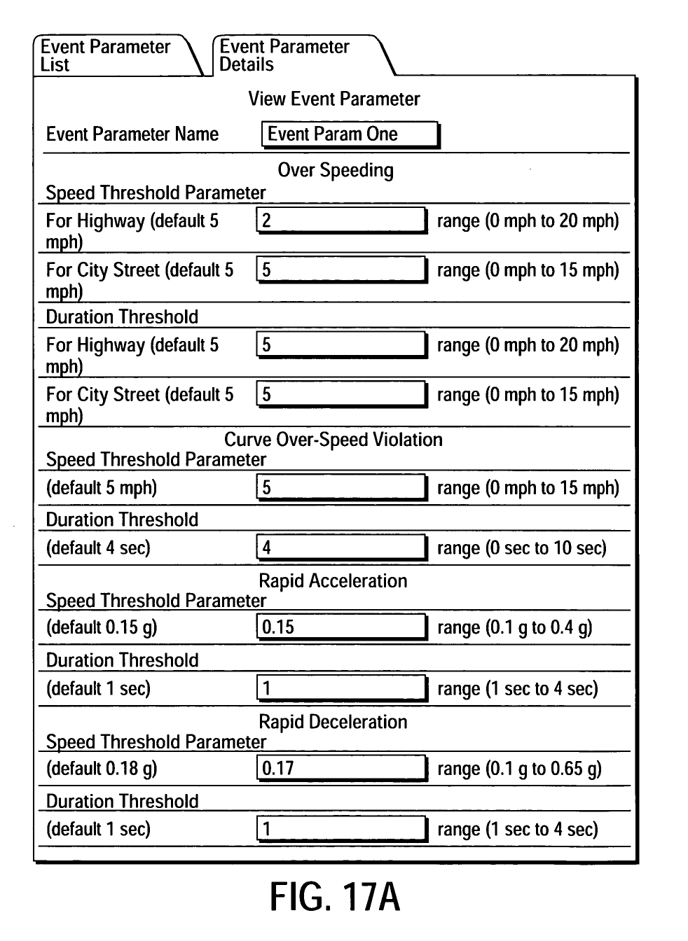

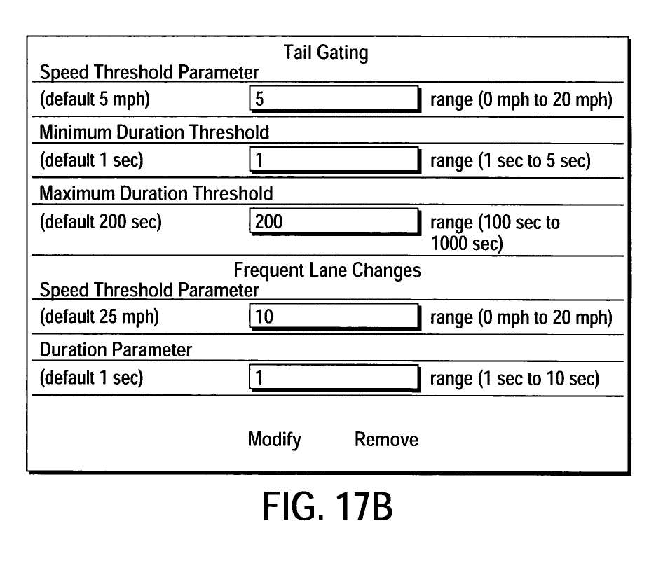

FIGS. 17a and 17b illustrate an example screen display for entering event parameters into the VSM system in accordance with one embodiment of the VSM user interface. At the top of the screen, a field for the “Event Parameter Name” is displayed. For this example screen, the event parameter name is “Event Param One.” For this embodiment, the screen display is divided into the unsafe driving events: Speed Over Limit or Over Speeding, Curve Over-Speed Violation, Rapid Acceleration, Rapid Deceleration, Tailgating and Frequent Lane Changes. Each unsafe driving event has one or more parameters. For example, the Over Speeding event has a “Speed Threshold Parameter” and a “Duration Threshold.” In addition, some parameters include a setting for both highway and city street. To set a parameter, a user types a value in the respective field. For example, a user may type 10 mph in the Speed Threshold Parameter for highway to limit the generation of Over Speeding events to vehicles traveling 10 mph over the speed limit on a highway. The use of each parameter is discussed above in the unsafe driving event section.

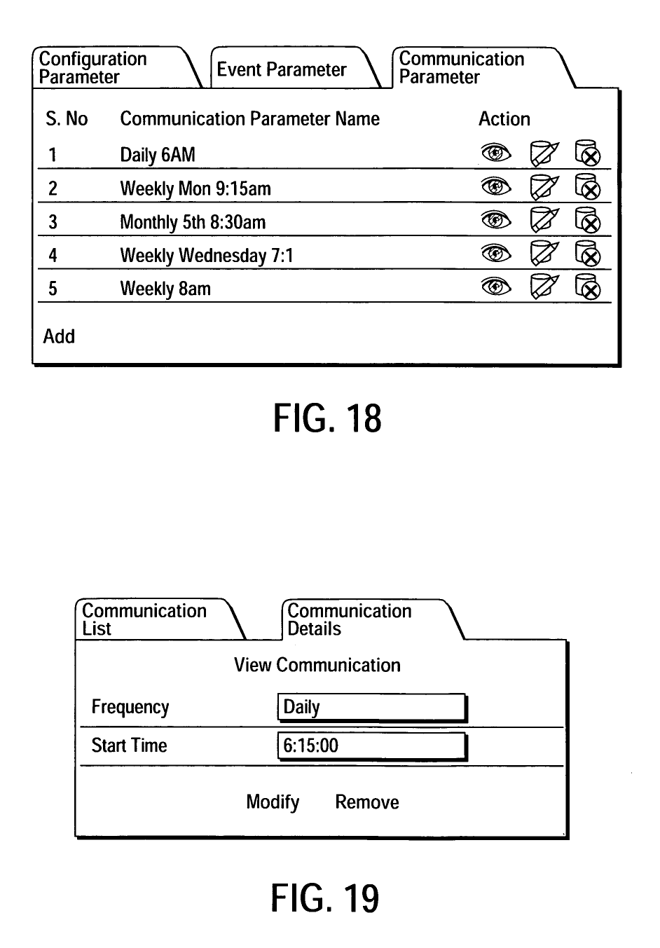

The VSM Hardware Configuration section of the VSM user interface further includes a section to enter and set-up communication parameters. In general, a communication parameter defines a time that detected events are sent from the VSM units to the Application Server. In non-real time systems, an AVL channel or a Store and Forward Gateway may be used. In a real time implementation, a wireless connection (e.g., 802.11x) may be used. FIG. 18 illustrates an example screen display for a list of communication parameters in accordance with one embodiment of the VSM user interface. In general, a communication parameter allows a user to define a time and frequency to transmit detected events from the VSM units to the Application Server. The example display of FIG. 18 lists, by name, the communication parameters generated for the customer. For the example of FIG. 18, the communication parameters include “Daily 6 AM”, “Weekly Mon 9:15 AM”, etc.). The icons to the right of the communication parameter permit the user to view details, save or delete. FIG. 19 illustrates an example screen display for communication details of a selected communication parameter in accordance with one embodiment of the VSM user interface. For the example display of FIG. 19, a user sets the start time of the communication parameter to “6:15” and the frequency of the parameter to “Daily.”

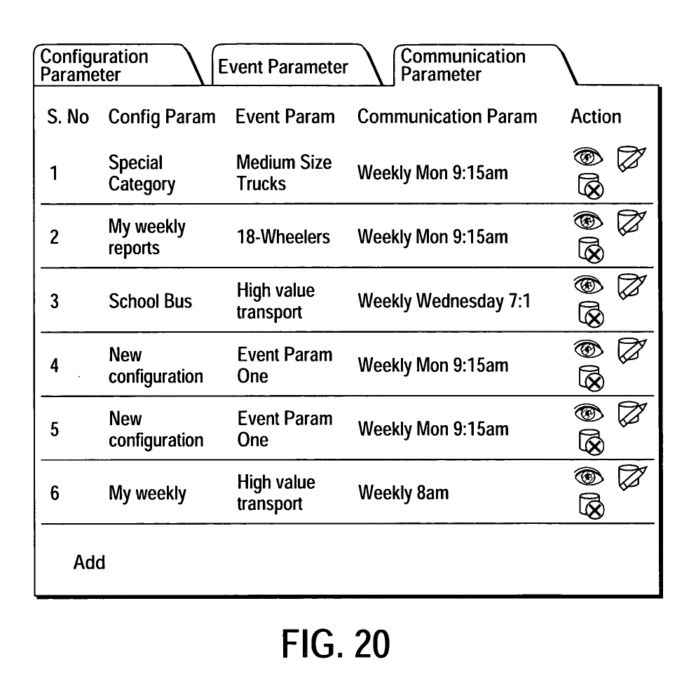

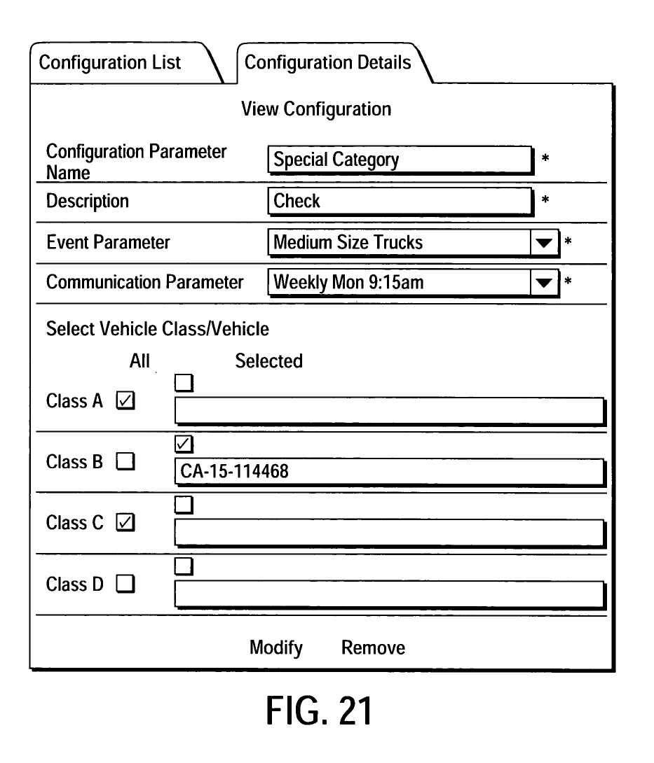

The VSM Hardware Configuration section of the VSM user interface also includes a section to enter and set-up configuration parameters. The configuration parameters allow a user to correlate or link an event parameter with a communication parameter for one or more vehicle classes. FIG. 20 illustrates an example screen display for a list of configuration parameters in accordance with one embodiment of the VSM user interface. The list of configuration parameters display includes the configuration parameter name, event parameter name, and communication parameter name. For example, for the first entry, the configuration parameter, Special Category, links the event parameter, Medium Size Trucks, with the communication parameter, “Weekly Mon 9:15 am.” The action icons to the right of the entries permit the user to view details, save and delete configuration parameters. FIG. 21 illustrates an example screen display for entering configuration parameter details in accordance with one embodiment of the VSM user interface. As shown in FIG. 21, the top of the display has an area to enter the configuration parameter name and description, as well as areas to link the configuration parameter to an event parameter and a communication parameter. The user may select an event parameter and a communication parameter from a list of event parameters and communication parameters generated for the customer. The bottom portion of the display permits a user to select vehicle classes or vehicles for the configuration parameter. For the example display of FIG. 21, classes A and C are selected along with the vehicle “CA-15-114468” within class B.

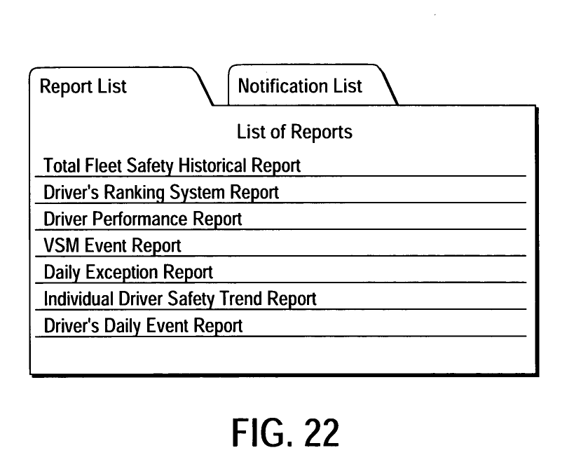

In one embodiment, the home page of the VSM user interface includes a selection for “Reports.” The VSM application generates various reports on unsafe driving behavior for the customer's fleet. FIG. 22 illustrates an example screen display for a list of reports available in accordance with one embodiment of the VSM user interface. For this embodiment, the VSM application generates the following reports: Total Fleet Safety Historical Report, Driver's Ranking System Report, Driver Performance Report, VSM Event Report, Daily Exception Report, Individual Driver Safety Trend Report, and Driver's Daily Event Report. In one embodiment, the user clicks, with a cursor control device, a report name, enters information to generate the report, and the VSM application generates the report.

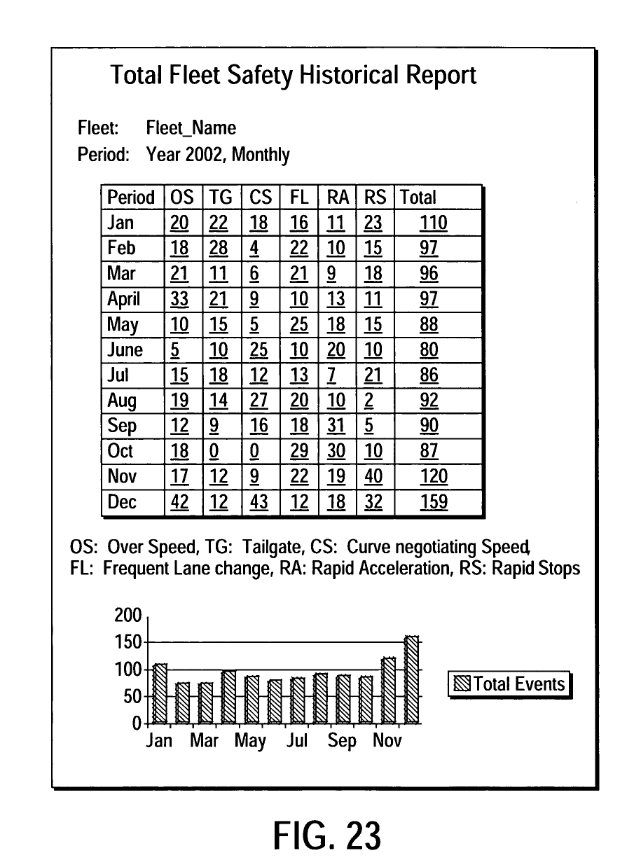

FIG. 23 illustrates one embodiment for a Total Fleet Safety Historical Report in accordance with one embodiment of the VSM application. In general, the Total Fleet Safety Historical Report identifies unsafe driving events, individually and in total, for a specified period of time. The report identifies the fleet and the period of time for the report. For the example of FIG. 23, the report identifies events by the month for the year 2002. The top portion of the report displays a table. For each month, the number of each type of event that occurred is displayed along with the total events for the month. For example, there were 21 tailgating events in April, and 97 total events. The bottom portion of the report depicts total event data in a bar graph.

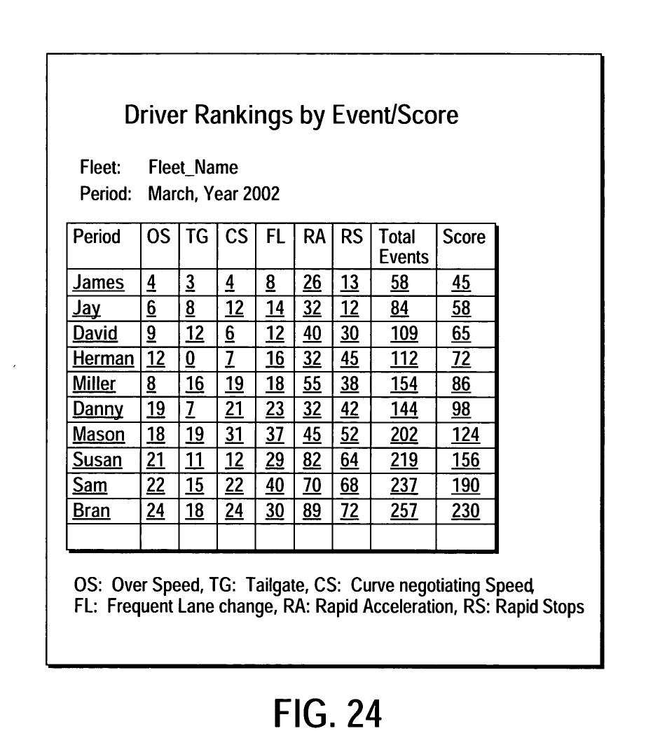

FIG. 24 illustrates one embodiment for a Driver Ranking by Event/Score Report in accordance with one embodiment of the VSM application. In general, the Driver Ranking by Event/Score Report identifies, for each driver, the number of specific events, the total number of events, and a score for a period of time. The example report of FIG. 24 identifies driver events for the month of March 2002 for the fleet, Fleet_Name. For example, the driver, Miller, had 55 rapid acceleration events.

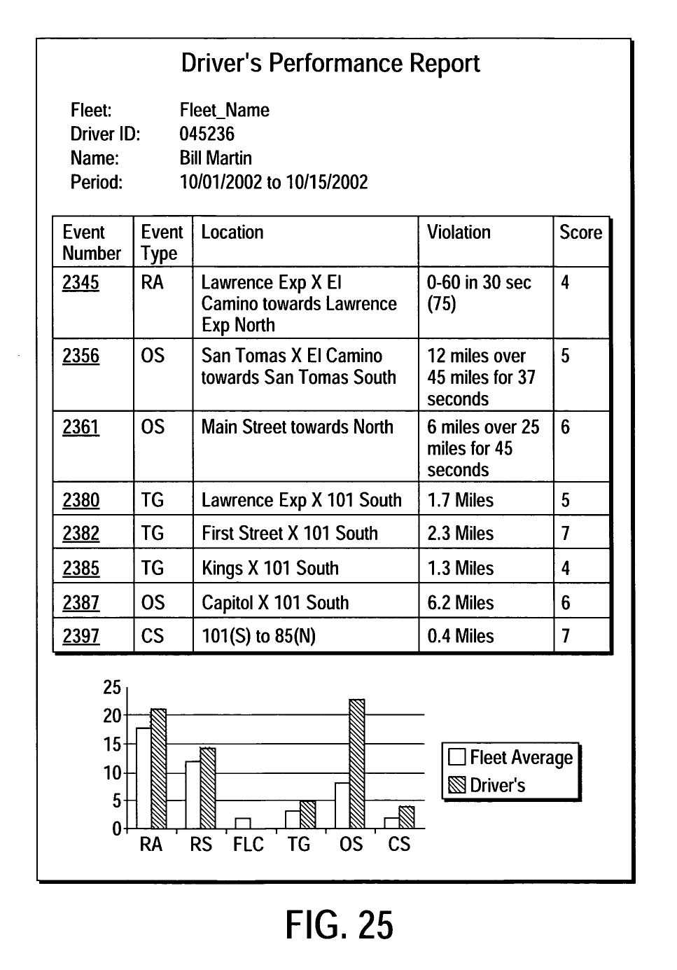

FIG. 25 illustrates one embodiment for a Driver's Performance Report in accordance with one embodiment of the VSM application. In addition to the fleet name, the report identified the driver by ID and name (e.g., James Ortiz). The example report of FIG. 25 covers the period from Oct. 1, 2002 to Oct. 15, 2002. The top portion of the report lists, in tabular form, each event generated for the driver in the specified period. For each event, an event number, event type, location, details of the violation, and a score are identified. For example, the second event in the table, event number 2356, is an Over Speed event that occurred in the vicinity of San Tomas Expressway and El Camino Real. The vehicle was driven at 12 mph over the 45 mph limit for 45 seconds. The bottom of the Driver's Performance Report includes a bar graph. The bar graph depicts the driver's individual events and the average events for all drivers in the fleet.

Various methodologies may be applied to calculate the score on these events for various business models. In some embodiments, the inputs used to calculate the scores include: a) Event Types, b) Duration of the events and c) Violation level over the threshold for that event type. The secondary inputs used to calculate the scores are, a) Time of the event detected, b) Geographical location where the event detected, c) Type of the vehicle (e.g., trucks vs. pickups) and d) Nature of the material being transported (e.g., hazardous waste material vs. public transportations). The third level of inputs used to calculate the reports include, 1) user supplied scoring mechanisms, b) commercially available tools, c) insurance company thresholds, etc.

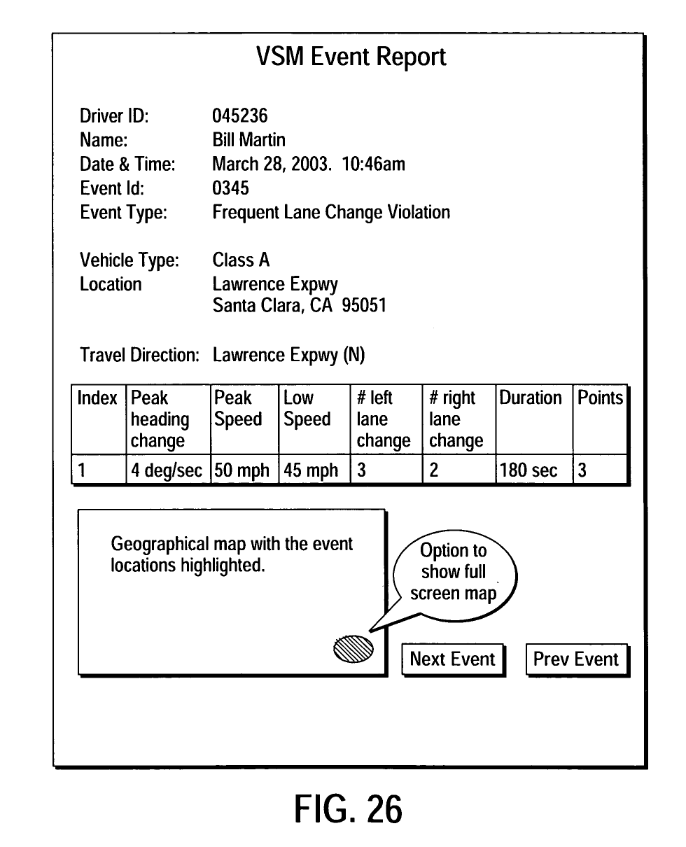

FIGS. 26-31 illustrate one embodiment for VSM Event Reports in accordance with one embodiment of the VSM application. A VSM Event Report includes information for a single event. A VSM Event Report identifies a driver, by driver ID and name, the event, by ID and type, and the date and time of the event. In addition, the VSM Event Report identifies the class of the vehicle and a location for the event. In the bottom portion of the report, a geographical map is displayed that highlights the location of the event. A “Next Event” and “Previous Event” area allow the user to scroll through a series of VSM Event Reports. As discussed more fully below, a VSM Event Report includes a table that identifies a variety of information for the event.

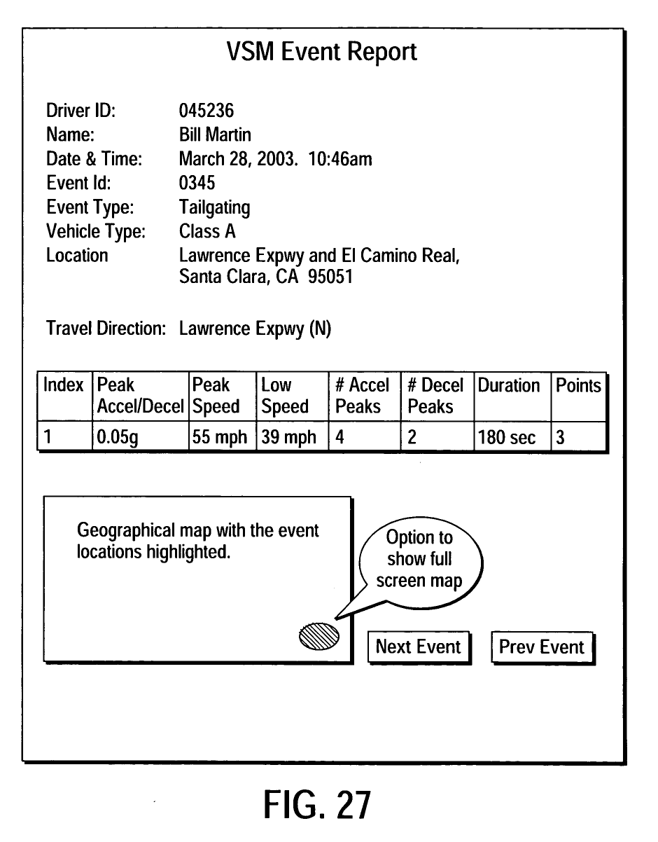

FIG. 26 illustrates an example VSM Event Report for a Frequent Lane Change Violation. The table for the VSM Event Report for a Frequent Lane Change Violation includes, peak heading change, peak speed, low speed, the number of left lane changes, the number of right lane changes, duration and points. FIG. 27 illustrates an example VSM Event Report for a Tailgating Violation. For the tailgating violation, the table specifies peak acceleration-deceleration, peak speed, low speed, the number of acceleration peaks, the number of deceleration peaks, duration of the event, and points.

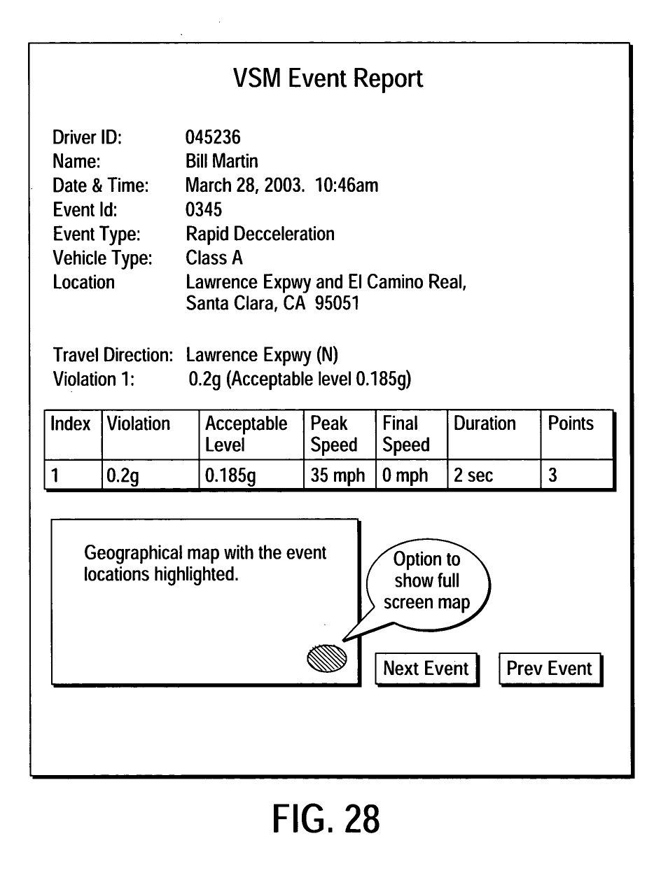

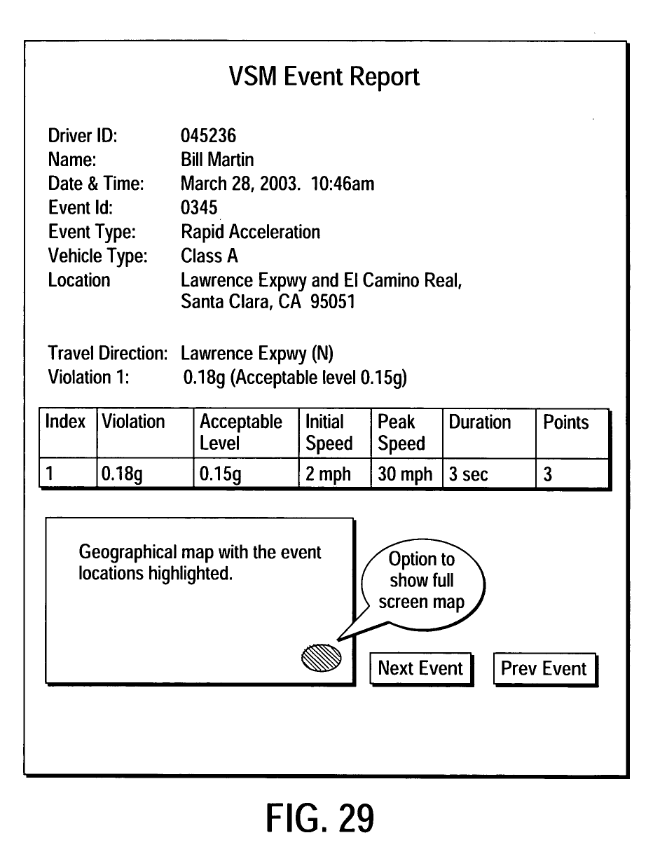

FIG. 28 illustrates an example VSM Event Report for a rapid deceleration event. The table for the VSM Event Report for a rapid deceleration event includes, the violation deceleration, the acceptable level of deceleration, peak speed, final speed, duration of the event and points. FIG. 29 illustrates an example VSM Event Report for a rapid acceleration event. The table for the VSM Event Report for a rapid acceleration event includes, the violation (e.g., acceleration), the acceptable level of acceleration, initial speed, peak speed, duration of the event and points.

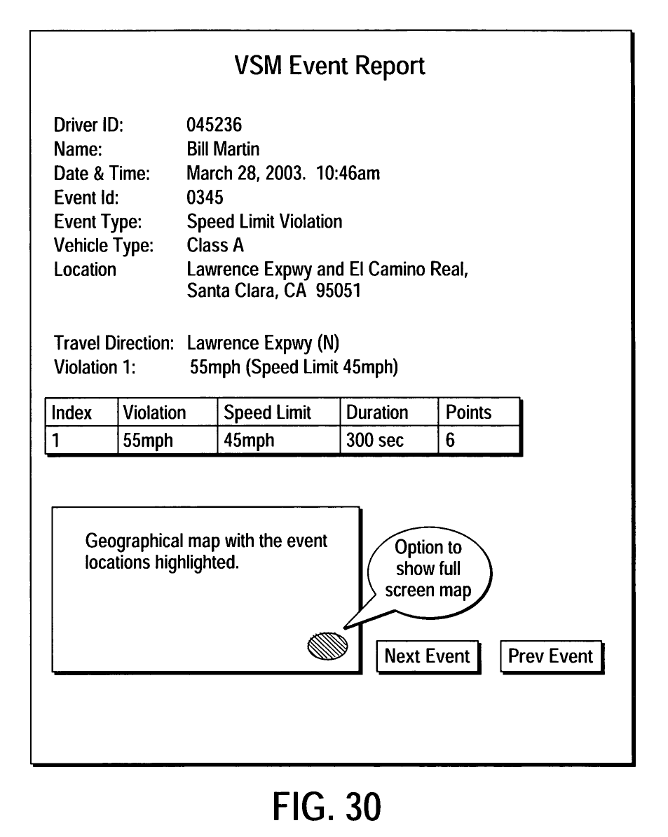

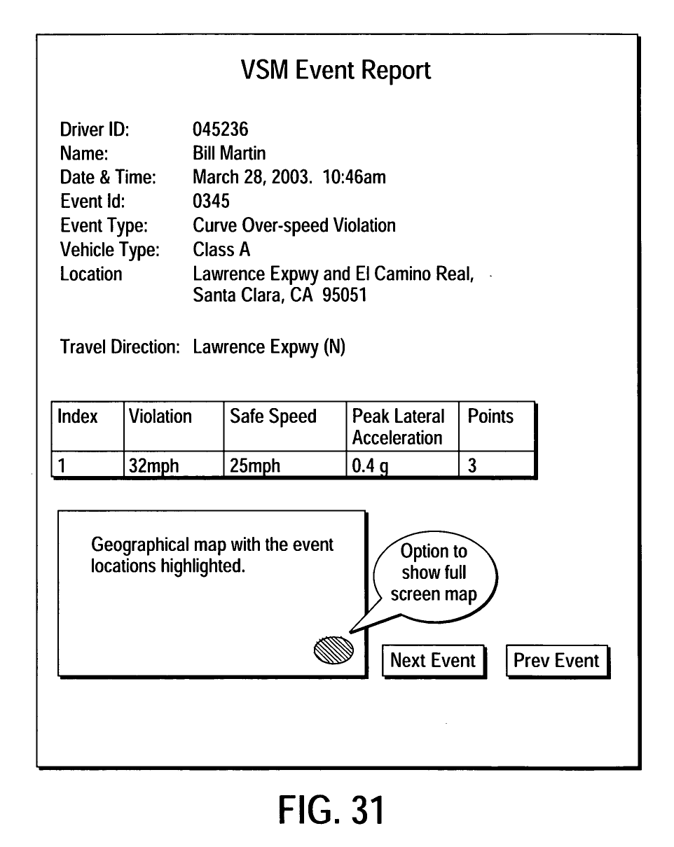

FIG. 30 illustrates an example VSM Event Report for a speed limit violation report. The table for the VSM Event Report for a speed limit violation event includes, the violation speed, speed limit, duration of the event and points. FIG. 31 illustrates an example VSM Event Report for a curve over speed violation report. The table for the VSM Event Report for a curve over speed violation event includes, the violation speed, the safe speed, peak lateral acceleration and points.

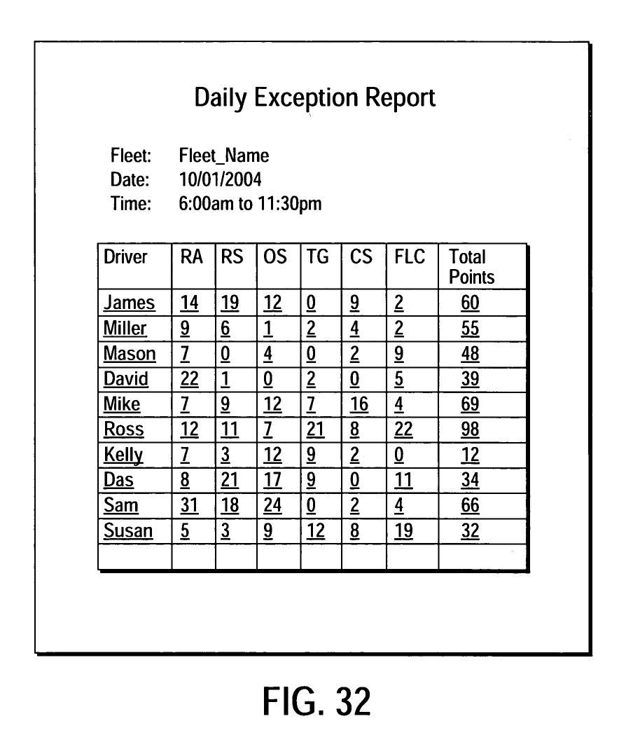

FIG. 32 illustrates one embodiment for a Daily Exception Report in accordance with one embodiment of the VSM application. The Daily Exception Report identifies, for each driver, each event and the total points for a driver for a specified day. For example, the driver “Susan”, had 12 tailgating incidents and thirty two total points.

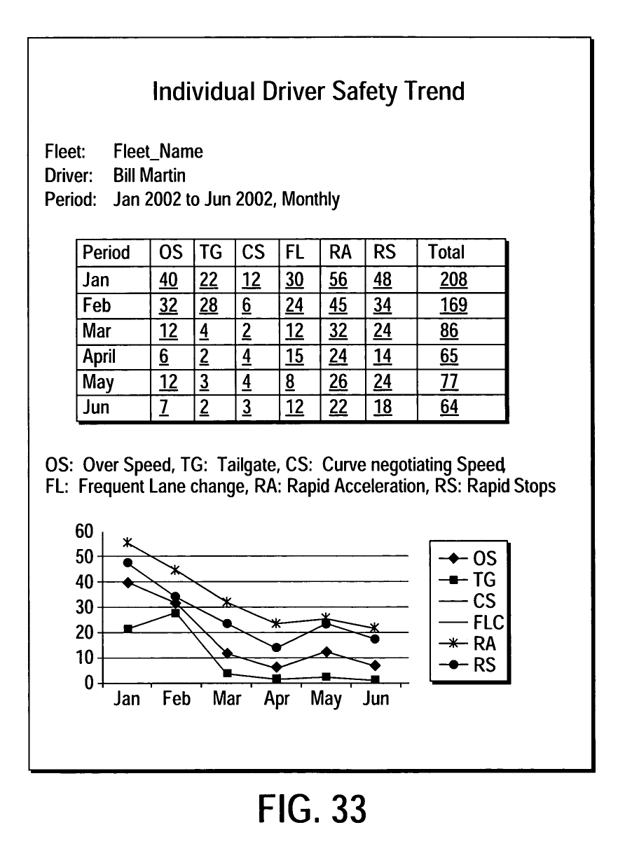

FIG. 33 illustrates one embodiment for an Individual Driver Safety Trend Report in accordance with one embodiment of the VSM application. The Individual Driver Safety Trend Report includes a table that identifies, for a driver, the number of individual events and the total number of events for a given period. For example, the driver has 28 tailgating events during the month of February. The bottom portion of the report charts each event over the period of the report.

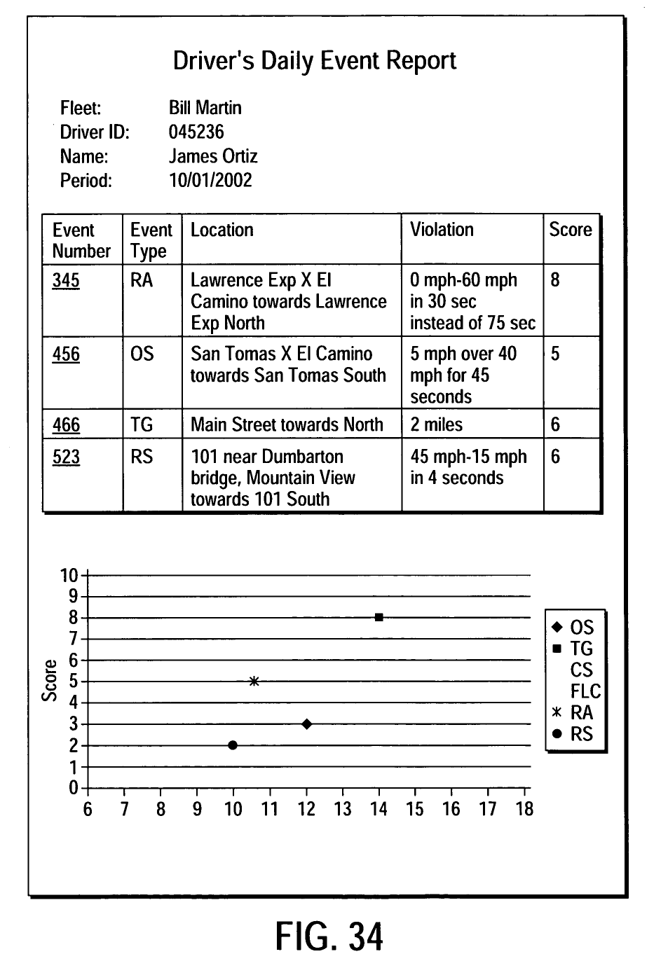

FIG. 34 illustrates one embodiment for a Driver's Daily Event Report in accordance with one embodiment of the VSM application. The Driver's Daily Event Report lists all of the events that occurred for that driver during a specified day. The portion of the report details the event by event number, event type, location, violation and score. The bottom portion of the report plots a score for each individual event.

Business Method and VSM Applications:

A business method is applied in a vehicle safety management system. An entity, implementing the business method, deploys the event detection modules on vehicles in a customer's fleet of vehicles. In one embodiment, the business entity may sell the event detection modules to the customer. As discussed above, the event detection module acquires vehicle data for parameters associated with movement of the vehicle, and generates event data based on unsafe driving events detected. The business entity sells access to the event data to the customer. For example, the customer may pay a subscription or license fee to the entity. As such, the entity may implement an application service provider (“ASP”) business model. A customer may create different configurations to characterize the event data in a manner most suitable for the customer.

The event data is transmitted from the event detection module on the vehicle to a server. In one embodiment, the application server implements a web site (disclosed above). For this embodiment, the customer uses the web site to gain access to the event data. The customer may also set the event parameters from the web site.

The VSM system may be used by fleet managers, insurance companies, risk management professionals, and training schools to generate a risk profile score. A risk profile score may characterize a fleet, a driver, or a group of drivers. The risk profile may be used by the entities to improve business methods and increase profitability. Specifically, entities may use the risk profile to design corrective measures. For example, a driver training school may use event data to identify areas of training for a driver. An insurance company may generate a statistical analysis of event data and scores for fleets and/or individuals to assess liability and to set premiums accordingly.

Although the present invention has been described in terms of specific exemplary embodiments, it will be appreciated that various modifications and alterations might be made by those skilled in the art without departing from the spirit and scope of the invention.

What is claimed is:

1. A method for detecting safe driving behavior in a vehicle, said method comprising:
defining a plurality of unsafe driving events, wherein an unsafe driving event characterizes movement of a vehicle in a manner indicative of unsafe driving behavior;
acquiring vehicle data for a plurality of parameters associated with movement of said vehicle;
processing said vehicle data in order to determine whether movement of said vehicle meets one or more pre-determined conditions; and
generating event data for one or more unsafe driving events if said processed vehicle data meets said pre-determined conditions.

2. The method as set forth in claim 1, wherein generating one or more unsafe driving events comprises transmitting, to a receiver remote from said vehicle, data for an unsafe driving event after said unsafe driving event is detected.

3. The method as set forth in claim 1, wherein generating one or more unsafe driving events comprises transmitting, to a receiver remote from said vehicle, data for an unsafe driving event only during specified time periods.

4. The method as set forth in claim 1, further comprising:
transmitting said data for an unsafe driving event to an application server; and
generating one or more reports to characterize unsafe driving behavior for said vehicle.

5. The method as set forth in claim 1, wherein acquiring vehicle data for a plurality of parameters associated with movement of said vehicle comprises sensing movement of said vehicle.

6. The method as set forth in claim 5, wherein sensing movement of said vehicle comprises sensing angular rate for yaw axis of said vehicle with a gyroscope.

7. The method as set forth in claim 5, wherein sensing movement of said vehicle comprises sensing acceleration in lateral and longitudinal axes of said vehicle with accelerometers.

8. The method as set forth in claim 1, wherein acquiring vehicle data for a plurality of parameters associated with movement of said vehicle comprises acquiring data from a global positioning system (“GPS”) receiver.

9. The method as set forth in claim 1, wherein an unsafe driving event comprises tailgating.

10. The method as set forth in claim 1, wherein an unsafe driving event frequent lane changes.

11. The method as set forth in claim 1, wherein an unsafe driving event comprises a speed limit violation.

12. The method as set forth in claim 1, wherein an unsafe driving event comprises a speed limit violation over a curved segment of road.

13. The method as set forth in claim 1, wherein an unsafe driving event comprises a rapid acceleration from a start.

14. The method as set forth in claim 1, wherein an unsafe driving event comprises a rapid deceleration to a stop.

15. A system for detecting safe driving behavior in a vehicle, said system comprising:
a plurality of unsafe driving events, wherein an unsafe driving event characterizes movement of a vehicle in a manner indicative of unsafe driving behavior;
circuit for acquiring vehicle data for a plurality of parameters associated with movement of said vehicle; and
processor, coupled to said circuit, for processing said vehicle data in order to determine whether movement of said vehicle meets one or more pre-determined conditions and for generating event data for one or more unsafe driving events if said processed vehicle data meets said pre-determined conditions.

16. The system as set forth in claim 15, further comprising a transmitter for transmitting, to a receiver remote from said vehicle, data for an unsafe driving event after said unsafe driving event is detected.

17. The system as set forth in claim 15, further comprising a transmitter for transmitting, to a receiver remote from said vehicle, data for an unsafe driving event only during specified time periods.

18. The system as set forth in claim 15, further comprising:
an application server;
a transmitter for transmitting said data for an unsafe driving event to said application server; and
wherein, said application server for generating one or more reports to characterize unsafe driving behavior for said vehicle.

19. The system as set forth in claim 15, wherein said circuit for acquiring vehicle data comprises one or more movement sensors.

20. The system as set forth in claim 19, wherein said sensor comprises a gyroscope for sensing angular rate for yaw axis of said vehicle.

21. The system as set forth in claim 19, wherein said sensor comprises a plurality of accelerometers for sensing acceleration in lateral and longitudinal axes of said vehicle.

22. The system as set forth in claim 19, wherein said circuit for acquiring vehicle data comprises a global positioning system (“GPS”) receiver.

23. The system as set forth in claim 15, wherein an unsafe driving event comprises tailgating.

24. The system as set forth in claim 15, wherein an unsafe driving event frequent lane changes.

25. The system as set forth in claim 15, wherein an unsafe driving event comprises a speed limit violation.

26. The system as set forth in claim 15, wherein an unsafe driving event comprises a speed limit violation over a curved segment of road.

27. The system as set forth in claim 15, wherein an unsafe driving event comprises a rapid acceleration from a start.

28. The system as set forth in claim 15, wherein an unsafe driving event comprises a rapid deceleration to a stop.
